(19) United States
(12) Patent Application Publication
(10) Pub. No.: US 2026/0317203 A1
(43) Pub. Date: Oct. 15, 2026

(54) COMPOSITE BIO-SORBENTS AND SORBENTS FOR THE SEPARATION OF RADIOACTIVE AND NON-RADIOACTIVE METAL IONS FROM AQUEOUS SOLUTION

(71) Applicant: Advanced Isotope Technologies, LLC, Mobile, AL (US)

(72) Inventor: Shameem Hasan, Sunrise, FL (US)

(73) Assignee: Advanced Isotope Technologies, LLC, Mobile, AL (US)

(21) Appl. No.: 19/699,733

(22) Filed: Jun. 5, 2026

Related U.S. Application Data
(62) Division of application No. 18/241,815, filed on Sep. 1, 2023.
(60) Provisional application No. 63/403,233, filed on Sep. 1, 2022.

(51) Int. Cl. C02F 1/28; C02F 1/62

(52) U.S. Cl. CPC C02F 1/288; C02F 1/62

(57) ABSTRACT

Chitosan-based hybrid composite materials and mesoporous titanium-based hybrid composite materials are disclosed. These hybrid composite materials can be used for the removal of toxic heavy metal ions from both radioactive and non-radioactive liquid waste streams. Stepwise methods of manufacturing these composite materials are further provided, as are methods of using the composites to remove heavy metal ions from aqueous solutions.

### CROSS-REFERENCE TO RELATED APPLICATIONS

This divisional application claims the benefit of U.S. patent application Ser. No. 18/241,815, filed on Sep. 1, 2023, which claims the benefit of U.S. Provisional Application Ser. No. 63/403,233, filed on Sep. 1, 2022, which are incorporated herein in their entirety by reference.

### FIELD OF THE INVENTION

The present disclosure relates generally to composite materials that may be utilized for separating metal ions from liquid waste streams.

### BACKGROUND

The pollution of the environment by both radioactive and non-radioactive metal ions is a significant concern, resulting from natural processes and human activities. Industries, particularly the metal finishing and medical sectors, employ a range of physical, chemical, and electrochemical processes that generate substantial volumes of wastewater containing toxic heavy metals. Furthermore, nuclear reactors used for power generation and weapon production contribute to the generation of radioactive metal contaminants in wastewater streams. Due to their long half-life and high radiological toxicity, the removal of these radioactive metal contaminants from nuclear facility-related wastewaters is of paramount importance for the environment and because of the potential negative impact these contaminants could have should the population be exposed.

Numerous methods have been developed for the removal of both radioactive and non-radioactive metal ions from wastewater, including chemical precipitation, evaporation, solvent extraction, membrane filtration, and ion-exchange processes. Among these methods, ion exchange has proven to be a highly effective and promising approach. Various ion-exchange resins have been reported in the literature for selectively removing metal ions from wastewater streams. However, each of these resins has its own advantages and limitations.

Numerous studies have explored chitosan resins, a partially acetylated glucosamine polymer derived from chitin found in abundance in crustacean shells, as an adsorbent due to its non-toxicity, metal chelation abilities, and biodegradability. For instance, Hasan (2005) investigated the removal of various metal ions from aqueous solutions using chitosan-coated perlite beads, demonstrating the pH-dependent metal ion uptake capacity and superior performance of modified chitosan beads compared to natural chitosan. Furthermore, chitosan-iron spherical beads were prepared to remove As(III) and As(V) from aqueous solutions, with reported adsorption capacities of 7.2 mg/g and 5.4 mg/g, respectively.

However, a challenge associated with chitosan-based adsorbents is their limited suitability for regeneration and repeated use due to changes in their physical and chemical properties during regeneration steps. Acidic solutions, commonly used for regeneration, can lead to the disintegration of chitosan-based adsorbents and reduced flow rates in continuous adsorption processes. To overcome this challenge, researchers have explored the cross-linking of chitosan with glutaraldehyde, resulting in acid-resistant materials. This cross-linking involves Schiff base reactions, creating a rigid network structure. While crosslinked chitosan exhibits improved acid resistance, its capacity for metal ions may be decreased compared to that of non-crosslinked chitosan beads.

Mesoporous titanium metal oxides have also been used as absorbents in various industrial applications due to their unique electronic and redox properties. The performance of these materials depends on mass transfer to active surface sites, charge transfer at the titania surface, and charge/ion transport within the material. For instance, the high surface area and ion exchange capabilities of mesoporous titanium metal oxides make them effective adsorbents for heavy metal ions such as lead (Pb), cadmium (Cd), and mercury (Hg). And Mesoporous titanium-based materials have demonstrated an impressive capacity to adsorb radioactive elements, including strontium (Sr), technetium (Tc), and uranium (U), from contaminated aqueous solutions. This property is particularly significant in the context of nuclear waste management and environmental remediation efforts around nuclear facilities.

However, while mesoporous titanium-based materials show great promise in environmental remediation, the regeneration of adsorbents after they have captured toxic metals and radioactive materials is a critical aspect. Developing efficient regeneration techniques that maintain the structural integrity and adsorption capacity has proven difficult. And achieving high selectivity for specific contaminants in complex mixtures is an ongoing research focus. Tailoring the surface chemistry of these materials to target particular metal contaminants still remains a challenge. Further, ensuring the long-term stability of mesoporous titanium metal oxides under radiation exposure remains an area of investigation, particularly in applications near nuclear facilities.

Accordingly, there is a need for low-cost adsorbent materials made of chitosan and titanium that possess high capacity and selective metal ion removal properties.

### SUMMARY

Chitosan-metal ion based composite materials may be prepared using phase inversion and aldol condensation processes. In addition, titanium-based mesoporous composite materials may be prepared using a sol-gel technique. These composite materials were found to be resistant to extreme pH, temperature and oxidation and reduction condition of the solution. For chitosan-iron (CF) composite resin, the SEM micrograph reveals that iron particles are heterogeneously distributed in the resin matrix. The EDS-x ray microanalysis of the CF composite resin shows the presence of C, O, N, and Fe presence in the resin matrix. The equilibrium adsorption capacity of CF-1 composite resin for arsenic was found to be dependent on the pH of the solution. In the case of 99Tc adsorption from simulated waste solution at 298K, both CF-1a and CF-2 composite resin can uptake more than 70% of 99Tc from caustic simulant. It is also observed that the CF-2a composite resin is found to be pH independent for adsorbing 99Tc from acidic to caustic simulant. Based on the cold test, it was concluded that 99mTc with high specific activity can be obtained by adding CF-2 or TF-based composite resin concentrator column unit in a 99Mo/99mTc(n,γ) generator system. This (n,γ) 99Mo based generator with concentrator column appeared to be deemed comparable to the fission based 99mTc/99Mo generator in terms of high specific activity. The QCR and CF—Hf based composite resin is found to be capable of extracting molybdenum from the mixed processing waste solution containing higher amounts of uranium. The TF-1 composite was found to be a potential candidate for Ge-68/Ga-68 generator systems. In addition, the CF-2CG, CR-POM, and Ti-POM composite materials can be used to concentrate gallium in a column, thus obtaining higher concentration from a Ge-68/Ga-68 generator system with low specific activity.

The foregoing summary has outlined some features of the biologically functional polynucleotide and method of production so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purpose of the biologically functional polynucleotide and method disclosed herein. Those skilled in the pertinent art should also realize that such equivalent designs or modifications do not depart from the scope of the biologically functional polynucleotide and method of the present disclosure.

### DESCRIPTION OF THE DRAWINGS

These and other features, aspects, and advantages of the present invention will become better understood with regard to the following description, appended claims, and accompanying drawings where:

FIG. 1 illustrates a chemical structure of chitin and chitosan.

FIG. 2 illustrates a reaction mechanism for the formation of chitosan-iron gel.

FIG. 3 illustrates a reaction mechanism for the preparation of water insoluble chitosan iron composite material.

FIG. 4 illustrates a reaction mechanism for the preparation of Chitosan-Fe(III)-Catechol water insoluble composite material.

FIG. 5 illustrates a reaction mechanism for the preparation of quaternized chitosan resin composite material resistant to extreme pH and oxidizing and reduction conditions.

FIG. 6 illustrates a schematic of reaction mechanism of titanium-based quaternary composite (TiP-Q).

FIG. 7 illustrates a chart illustrating the equilibrium adsorption of both arsenic (III) and arsenic (V) from aqueous solution by a partially oxidized chitosan-Fe composite resin.

FIG. 8A illustrates a scanning electron micrograph (SEM) of cross-section of chitosan-Fe composite resin exposed to arsenic.

FIG. 8B illustrates an EDS X-ray microanalysis of a cross-section of chitosan-Fe composite resin exposed to arsenic.

FIG. 9 illustrates the effect of a simulant pH on different chitosan-Fe composite resins for the adsorption of Tc-99.

FIG. 10A illustrates a schematic of a possible (n,γ) ⁹⁹Mo/^{99m}Tc generator system with (n, γ) ⁹⁹Mo column and concentrator.

FIG. 10B illustrates a schematic of a possible (n,γ) ⁹⁹Mo/^{99m}Tc generator system with a concentrator column for pertechnetate with high specific activity (SA).

FIG. 11A illustrates equilibrium uptake of molybdenum on quaternized chitosan composite resin from different percentages of molybdenum and uranium solution.

FIG. 11B illustrates equilibrium uptake of molybdenum on chitosan-Hf composite resin from different percentages of molybdenum and uranium solution.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally. The term “comprises” and grammatical equivalents thereof are used herein to mean that other components, steps, etc. are optionally present. For example, a system “comprising” components A, B, and C can contain only components A, B, and C, or can contain not only components A, B, and C, but also one or more other components.

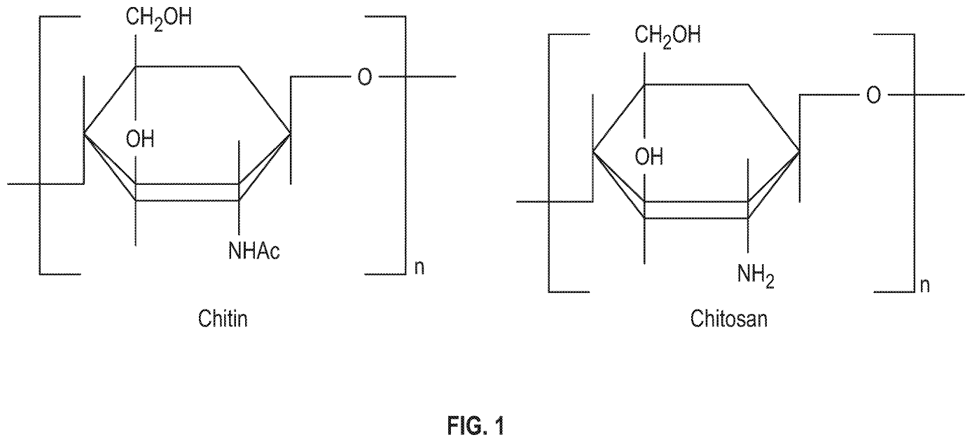

FIGS. 1-11B illustrate embodiments of chitosan based and titanium based composite materials used for the separation of radioactive and non-radioactive metal ions from aqueous solutions as well as methods for production and performance. Table 1 illustrates brief preparation steps for chitosan-based composites and their particle size.

TABLE 1
Description of brief preparation steps for chitosan-iron (CF) composite resins

| CF based | | Particle |
|---|---|---|
| resin | Preparation steps in brief | size |
| CF-1 | Step-1: Preparation of chitosan and iron nitrate gel at 70 °C | 100 to |
| | Step-2: Dropwise addition of 50% glutaraldehyde to step-1 provides water | 300 |
| | insoluble semi-solid chitosan-iron composite. | micron |
| | Step-3: Approximately 0.5M NaOH solution was used for rapid | |
| | neutralization of the reaction mass from step-2 under continuous stirring. | |
| | Step-4: The composite mass from the step-3 was thoroughly washed with | |
| | deionized (DI) water to obtain near neutral mass. | |
| | Step-5: Drying, grinding, and sieving | |
| CF-1a | Step-1: Preparation of chitosan and iron nitrate gel at 70 °C. | 100 to |
| | Step-2: Addition of 50% glutaraldehyde to step-1 to prepare water | 300 |
| | insoluble semi-solid chitosan-iron composite | micron |
| | Step-3: The composite mass from the step-2 was thoroughly washed with | |
| | deionized (DI) water to remove unreacted cross-linking agent | |
| | Step-4: Drying, grinding, and sieving | |
| CF-1b | Step-1: Reduction of CF-1a resin using 1M NaBH₄ solution. The reduced | 100 to |
| | form of CF-1a resin is termed as CF-1b in this study. Following reduction | 300 |
| | process, the CF-1b composite resin was rinsed with DI water to remove | micron |
| | any adhered reducing agent before being used. | |
| CF-2 | Step-1: Approximately 0.2-gram oxalic acid solution was used to prepare | 100 to |
| | chitosan gel. | 300 |
| | Step-2: To this, calculated amount of iron chloride solution was added | micron |
| | slowly under continuous stirring and heating to obtain a clear sol without | |
| | any precipitation. | |
| | Step-3: Addition of 50% glutaraldehyde to step-2 was carried out slowly | |
| | to obtain water insoluble semi-solid chitosan-iron composite. | |
| | Step-4: the semi-solid composite mass from the step-3 was washed | |
| | thoroughly with DI water to remove any unreacted cross-linking agent. | |
| | Step-5: Drying, grinding, and sieving. | |
| CF-2a | Step-1: Dried composite mass of CF-2 was reduced using 1M NaBH₄ | 100 to |
| | solution overnight. | 300 |
| | Step-2: The mass was separated from the NaBH₄ solution and then rinse | micron |
| | with DI water to remove any adhered reducing agent and air dried before | |
| | being used. | |

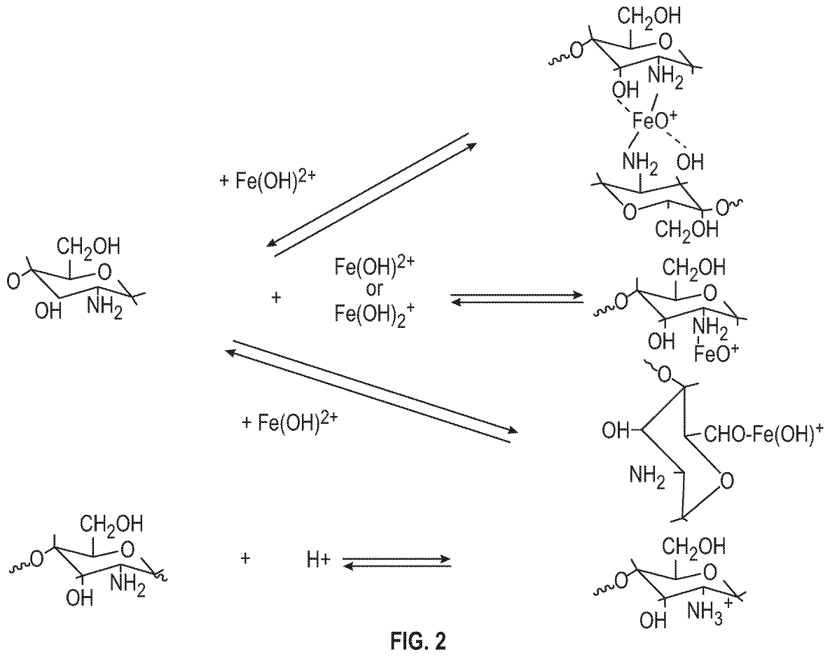

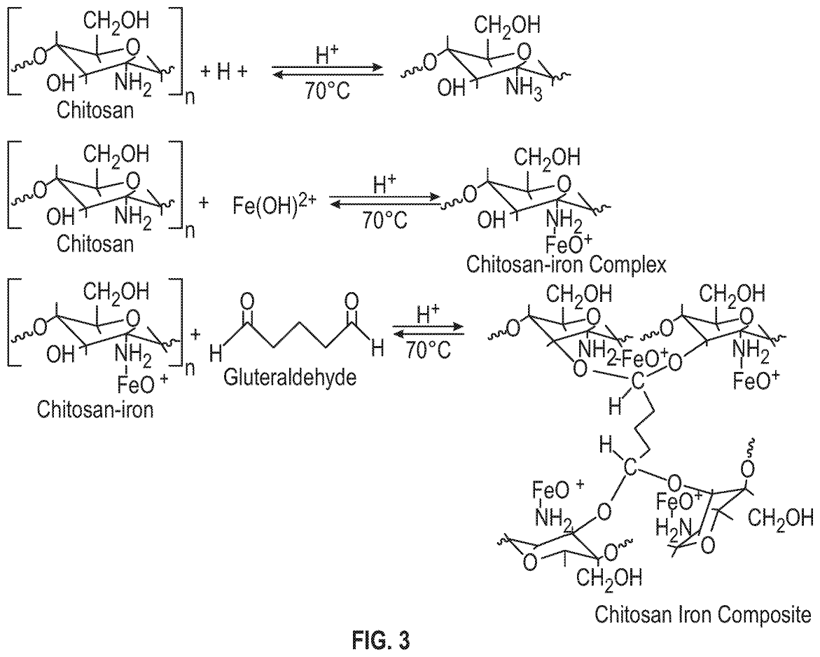

The structures of chitin and chitosan are illustrated in FIG. 1. Iron can form a complex with amine and —OH groups of the biopolymer, as illustrated in FIG. 2. The formation of a complex between carboxylic groups and iron is possible or the carboxylic groups may form a bridge between iron and chitosan. In CF-1 composite preparation, chitosan may be dissolved in iron nitrate solution, allowing for the chemical bonding between chitosan and iron oxide to occur and form chitosan-iron complex. FIG. 3 illustrates the possible reaction pathways for the preparation of CF-1 composite material.

In a preferred embodiment, a CF-1 composite resin is created by first mixing under continuous stirring a certain weight of ferric nitrate (Fe(NO₃)₃) in deionized (DI) water so that the resulting Fe(NO₃)₃ solution has a pH of ~3.0. An equal amount by weight of chitosan is then added to the Fe(NO₃)₃ solution via stirring and under continuous heating until a chitosan-iron gel is formed. In a preferred embodiment, the Fe(NO₃)₃ solution is heated to a constant temperature of 343K (70° C.). After the formation of the chitosan-iron gel, glutaraldehyde (GLA) may be added to the chitosan-iron gel, which is preferably kept at a constant temperature and under continuous stirring. In a preferred embodiment, the glutaraldehyde is added to the chitosan-iron gel once the chitosan-iron gel has reached a volume that is half of that of the original volume of water used to create the Fe(NO₃)₃ solution. The addition of the glutaraldehyde to the chitosan-iron gel results in a cross-linking reaction that creates a semi-solid gel. In a preferred embodiment, the chitosan-iron gel is continuously stirred at a rate of ~300 rpm and is heated to a constant temperature of 343K (70° C.) as the glutaraldehyde is added. In another preferred embodiment, glutaraldehyde is preferably added to the chitosan-iron gel via drop wise addition. FIG. 3 illustrates the possible reaction mechanism of glutaraldehyde with chitosan-iron gel for the formation of chitosan-iron (CF) composite through the formation of acetal bonds.

The semi-solid gel is then suspended in DI water and subsequently washed thoroughly under stirring to remove any unreacted glutaraldehyde. The cleaned semi-solid gel is then separated from the DI water and suspended in a NaOH solution under stirring in a way that causes the iron particles within the chitosan matrix to react and create a reacted semi-sold gel. In a preferred embodiment, the cleaned semi-solid gel is suspended 0.1M NaOH solution under stirring (~200 rpm) in order to assist with the neutralization of the semi-solid mass and allow for the formation of FeOOH particles as the iron content of the cleaned semi-solid gel reacts with NaOH. Because the iron particles are trapped in the chitosan matrix, further agglomeration of larger particles may be prevented. The reacted semi-solid gel is then separated from basic solution and washed thoroughly with DI water until the pH of the washed solution is near neutral (~6.5-7.0) to create a washed, reacted semi-solid gel. The washed, reacted semi-solid gel is then dried, resulting in the CF-1 composite resin. In some preferred embodiments, the CF-1 composite resin may be ground in a way such that the CF-1 composite resin has a particle size within the range of ~100 to 300 μm for subsequent use.

A CF-1a composite resin may be obtained in a similar manner as the CF-1 composite resin. The chitosan-iron gel used to create the CF-1a composite resin is preferably prepared following the process for creating the chitosan-iron gel created for CF-1 composite resin. The addition of glutaraldehyde to the chitosan-iron gel is also preferably performed in a similar manner, wherein the glutaraldehyde is added dropwise to the chitosan-iron gel kept at a constant temperature and under continuous stirring once the total volume of the chitosan-iron gel has been reduced to less than the half of the original volume. The resulting semi-solid gel is subsequently washed with DI water under stirring to remove any unreacted glutaraldehyde to create cleaned semi-solid gel. However, instead of suspending the cleaned semi-solid gel in a basic solution, the cleaned semi-solid gel is instead dried, resulting in a CF-1a composite resin. In some preferred embodiments, the CF-1a composite resin may be ground in a way such that the CF-1a composite has a particle size within the range of ~100 to 300 μm for subsequent use. The CF-1a composite resin is not finally neutralized by suspension in an NaOH solution. Rather it was just simply washed with DI water before being dried in the oven. CF-1b composite resin is the reduced form of CF-1a resin and the reduction step may be performed using 1M NaBH₄ under continuous stirring overnight.

For CF-2 composite resin preparation, oxalic acid may be used to dissolve chitosan in solution. Oxalic acid is a dicarboxylate used to form ionic crosslinks between the carboxylic groups of oxalic acid and amine groups of chitosan. The carboxylic groups may form hydrogen bonds with —OH, and CH₂OH groups of chitosan. In a preferred embodiment, a CF-2 composite resin may be obtained by first mixing chitosan with an oxalic acid solution to create a chitosan-oxalic acid gel, resulting in chitosan-oxalic acid gel that will have a higher ionic conductivity in the gel matrix. To this, approximately 20 mL of a Fe(NO₃)₃ solution is slowly added under continuous stirring and heating. The Fe(NO₃)₃ solution is preferably made in the same manner as it is prepared for the production of CF-1 composite resin. The resulting clear solution of chitosan, oxalic acid and iron nitrate mixture may be kept under continuous stirring and heating at 343K (70° C.) until the volume of the clear solution is reduced to less than half of the original volume. Once the volume of the clear solution has decreased by at least half, the dropwise addition of glutaraldehyde under continuous stirring of the clear solution may be performed to cause a cross-linking reaction to occur, creating a semi-solid gel. The semi-solid gel is preferably thoroughly washed with DI water under stirring and filtered to remove any unreacted glutaraldehyde. The resulting cleaned semi-solid gel is then dried so that a CF-2 composite resin may be obtained. In some preferred embodiments, the CF-2 composite resin may be ground in a way such that the CF-2 composite resin has a particle size within the range of ~100 to 300 μm for subsequent use.

For example, a 0.2M oxalic acid solution may be prepared by dissolving approximately 2.53-gram oxalic acid in 200 mL DI water, wherein approximately 4-gram of chitosan may be added to the oxalic acid solution. In a preferred embodiment, the chitosan comprises a high molecular weight. In another preferred embodiment, the chitosan and oxalic acid solution are continuously stirred (preferably at 500 rmp) and kept at a constant temperature of 343K (70° C.) until a chitosan-oxalic acid gel forms. To this, approximately 20 mL of 4 g Fe(NO₃)₃ solution may be added under continuous stirring and constant heat of approximately 343K (70° C.) using a heating bath. When the volume of the clear solution is reduced to less than half of the original volume, about 5 mL of glutaraldehyde may be added to the clear solution dropwise under continuous stirring, resulting in a cross-linking reaction. A semi-solid gel is subsequently formed upon the completion of the cross-linking reaction, and that semi-solid gel may be washed, filtered, and dried to obtain a CF-2 composite resin. In a preferred embodiment, the semi-solid gel is dried at approximately 343K (70° C.) overnight.

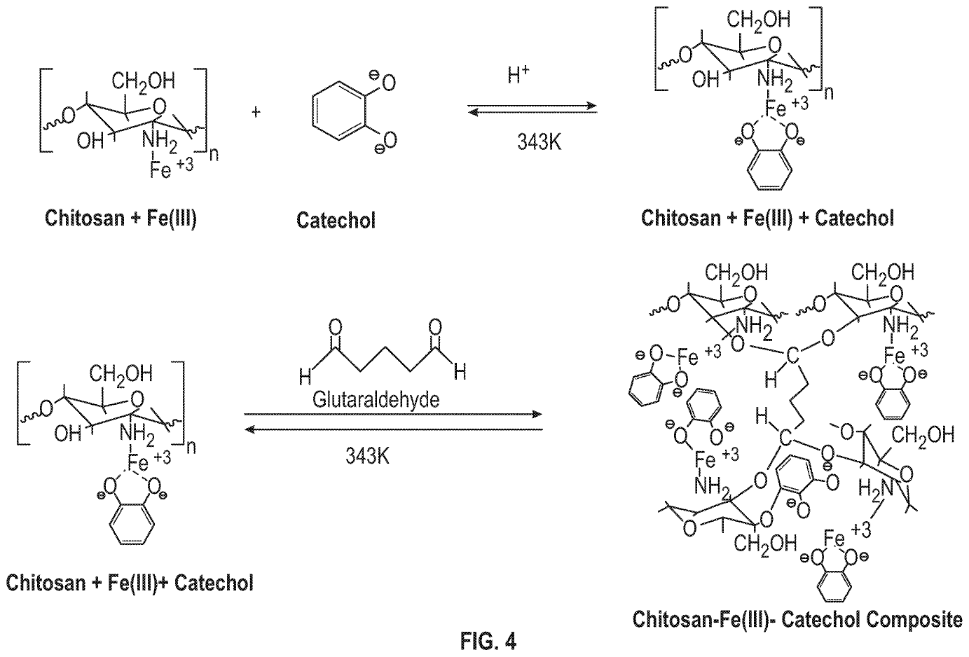

In yet another preferred embodiment, as illustrated in FIG. 4, a cross-linked chitosan-iron-catechol-glutaraldehyde (CF-2CG) composite resin may be obtained in a way that creates a matrix comprising Fe³⁺ and catechol, wherein the Fe³⁻ forms strong coordination bonds with the catechol. The reaction between iron and catechol can be describe as follows:

Fe(III)+C₆H₄(OH)₂→[Fe³⁺+(Cat−2H⁺)+2Cl⁻]⁻ (1)

Fe³⁺ mediated oxidation of catechol is a slow process at room temperature (RT). However, that oxidation process may be accelerated in presence of acid as a catalyst at an elevated temperature. Furthermore, a strong cation-π interaction between catechol and protonated amine groups of chitosan may further enhance the degree of cross-linking and hence cohesiveness of the composite resin. In order to make the reaction product of chitosan-iron-catechol acid resistant, it was further crosslinked with glutaraldehyde. The following method may be used to create a CF-2CG composite resin.

A chitosan iron gel may be prepared under continuous stirring in the presence of H⁺. Ferric chloride solution may be added to the chitosan iron solution under continuous stirring and heating to form a chitosan solution to which a catechol solution may be subsequently added, resulting in a chitosan-iron-catechol mixture. The dropwise addition of glutaraldehyde may then result in a cross-linking reaction to take place between chitosan, iron, catechol, and glutaraldehyde, causing a semi-solid gel to form. The gel may then be washed with deionized water to remove any unreacted reagents and subsequently dried to obtain a CF-2CG composite resin. In some preferred embodiments, the CF-2CG composite resin may be ground in a way such that the CF-2CG composite resin has a particle size within the range of ~100 to 300 μm for subsequent use.

For example, approximately 4 grams of chitosan may be added to 200 mL of deionized (DI) water with 2 mL HCl acid and stirred (<500 rpm) for 3 hours at 343K (70° C.) to form clear chitosan solution. About 4 grams of FeCl₃ (anhydrous) may then be dissolved in 20 mL deionized water to create a ferric chloride solution that may be slowly added to the clear chitosan solution under continuous stirring and heating at 343K (70° C.) to avoid precipitation. To this, 0.5 gram of catechol in 10 mL deionized water may be mixed under continuous stirring and heating at 343K (70° C.). Glutaraldehyde may then be added to the chitosan-iron-catechol mixture following the CF-1 preparation process described above. During continuous stirring and heating at 343K, the polymerization reaction occurs between chitosan, iron, catechol, and glutaraldehyde, ultimately resulting in a semi-solid gel. At room temperature, the gel may then be thoroughly washed with deionized water to remove any unreacted components, and without any further treatment, the cleaned semi-solid gel may be dried in an oven overnight at 343K (70° C.), resulting in the CF-2CG composite resin.

In yet another preferred embodiment, CR composite resin may be prepared using the following method. Chitosan may be added to DI water and HCl under constant heat and stirring to form a chitosan gel. When the chitosan gel reaches a volume is reduced by at least half, glutaraldehyde may be added to the chitosan gel under constant stirring and heat until a crosslinked mass is obtained. The crosslinked mass may be cleaned to remove any unreacted reagents, and the cleaned, crosslinked mass may then be suspended in a sodium hypochlorite solution (NaOCl) under continuous stirring in order to partially deprotonate the protonated NH₃⁺ groups of the composite resin. The deprotonated, crosslinked mass may be separated from the NaOCl solution and washed with DI water until the pH of the washed solution become near neutral. The cleaned, deprotonated, crosslinked mass may then be dried, resulting in the CR composite resin. In some preferred embodiments, the CR composite resin may be ground in a way such that the CR composite resin has a particle size within the range of ~100 to 300 μm for subsequent use.

For example, about 4 grams of chitosan may be added to 200 mL of DI water with 4 mL of HCl and stirred (500 rpm) for at least 2 hours at 343K (70° C.) using a heating bath to form a chitosan gel. The reaction of glutaraldehyde cross-linking with the chitosan gel may be performed at 343K (70° C.) by dropwise addition of 5 mL of glutaraldehyde once the total volume of the chitosan gel has been reduced to half of the original volume. The resulting crosslinked mass is preferably kept under continuous stirring at 343K (70° C.) until a crosslinked mass is obtained. The resulting crosslinked mass may be washed thoroughly with DI water to remove any unreacted glutaraldehyde and subsequently suspended in 5 mM sodium hypochlorite (NaOCl) solution for 6 to 12 hours under continuous stirring (200 rpm) to neutralize the crosslinked mass. The deprotonated crosslinked mass may then be separated from the solution and further washed with DI water until the pH of the washed solution become near neutral. The resulting cleaned, deprotonated crosslinked mass may then be dried in an oven at 343K (70° C.) overnight to obtain the CR composite resin.

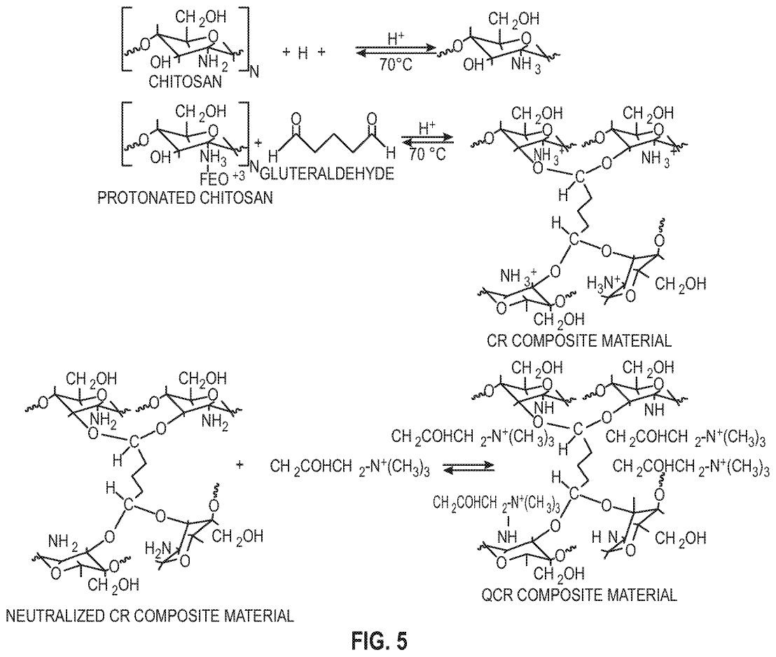

In yet another preferred embodiment, as illustrated in FIG. 5, a QCR composite resin that is resistant to extreme pH, oxidation and reduction conditions may be prepared by dissolving glycidyltrimethylammonium chloride (GTMAC) and CR composite resin in DI water under continuous stirring. The resulting GTMAC crosslinked mass may be separated from the solution, rinsed with DI water and subsequently dried to obtain the QCR composite resin. In some preferred embodiments, the QCR composite resin may be ground in a way such that the QCR composite resin has a particle size within the range of ~100 to 300 μm for subsequent use. For example, approximately 2 grams of glycidyltrimethylammonium chloride (GTMAC) may be dissolved in 20 mL of DI water to create a GTMAC solution. To this, approximately two (2) grams of CR composite resin may be added, and the mixture may be kept under continuous stirring (200 rpm) at 298K (25° C.) for overnight. The resulting GTMAC crosslinked mass may then be separated from the solution and rinsed with DI water to remove any adhered reagents. The cleaned, crosslinked mass may then be dried in an oven at 318K (45° C.) overnight in order to obtain the desired QCR composite resin.

In yet another preferred embodiment, a CR-HF composite resin may be obtained by dispersing Hafnium onto the chitosan matrix to create a self-oxidizing complex. A water-soluble hafnium source, such as hafnium chloride (HfCl₂O·8H₂O), may be combined with chitosan to create a chitosan-hafnium mass under continuous stirring and heating. When the volume of the chitosan-hafnium mass is reduced to less than half of the original volume, glutaraldehyde may be added to the chitosan-hafnium mass in a dropwise manner while the chitosan-hafnium mass is under continuous stirring. The resulting thick, chitosan-hafnium gel may be washed with DI water under stirring and subsequently filtered to remove any unreacted reagents. The cleaned, chitosan-hafnium gel may then be dried to obtain the desired CR-Hf composite resin. In some preferred embodiments, the CR-HF composite resin may be ground in a way such that the CR-HF composite resin has a particle size within the range of ~100 to 300 μm for subsequent use.

For example, approximately one (1) gram hafnium chloride (HfCl₂O·8H₂O) and four (4) grams of chitosan may be dissolved in DI water to create a clear solution of chitosan and hafnium chloride having no precipitate. The mixture is preferably kept under continuous stirring and heating at 343K (70° C.) using a heating bath. When the volume of the mixture is reduced to less than half of the original volume, about 6 mL of glutaraldehyde may be added to the chitosan-hafnium mass in a dropwise manner under continuous stirring. A thick, chitosan-hafnium gel is formed within 5 minutes upon the completion of the cross-linking reaction. The thick, chitosan-hafnium gel may then be washed thoroughly with DI water under stirring and filtered to remove any unreacted cross-linking agents. The thick, chitosan-hafnium gel may then be dried in an oven at 343K (70° C.) overnight, resulting in the CR-Hf composite resin.

In yet another preferred embodiment, a CR-POM composite resin may be created using the following method. An amount of water soluble molybdate source, water-soluble manganese source, water-soluble phosphate source, water-soluble tungstate source, and water-soluble cobalt source are dissolved in a beaker containing a phosphoric acid solution under continuous stirring to obtain a clear solution. In one preferred embodiment, an equal amount by weight of said water-soluble manganese source, water-soluble phosphate source, water-soluble tungstate source, and water-soluble cobalt source are dissolved. The clear mixed solution may then be added dropwise onto a chitosan solution (matrix) under continuous stirring and heating following the CF-1 composite resin preparation process in order to create a mixed chitosan mass. H₃PO₄ solution is preferably added dropwise to the chitosan solution to prepare the chitosan solution for the addition of the clear mixed solution. When the volume of the mixed chitosan mass is reduced to less than half of the original volume, glutaraldehyde may be added under continuous stirring to create a thick, mixed chitosan gel. The thick, mixed chitosan gel may be washed thoroughly with DI water and subsequently filtered to remove any unreacted reagents and inorganic salts. The cleaned, mixed chitosan gel may then be dried to obtain a dried, mixed crosslinked mass that may subsequently be suspended in a NaOCl solution to the oxidize the dried, mixed crosslinked mass in order for the desired CR-POM composite resin to be obtained.

For example, approximately 0.5 gram of sodium molybdate, manganese chloride, sodium phosphate, sodium tungstate, and cobalt chloride may be added to a beaker containing 10 mL of phosphoric acid (10%) solution under continuous stirring to obtain a clear mixed solution. This clear mixed solution may be added dropwise to a chitosan solution of approximately 4-grams of chitosan and 200 mL of deionized water that was previously treated with at least 2 mL H₃PO₄ (50%) in order to create a mixed chitosan mass. When the volume of the mixed chitosan mass is reduced to at least half of the original volume, about 6 mL of glutaraldehyde may be added to the mixed chitosan mass in a dropwise manner under continuous stirring. A thick, mixed chitosan gel may be formed within approximately 5 minutes upon the completion of the cross-linking reaction. The thick, mixed chitosan gel may then be washed thoroughly with DI water and filtered to remove any unreacted cross-linking agents and inorganic salts. The cleaned, mixed chitosan gel may then be dried in an oven at 343K (70° C.) overnight in order to obtain a dried, mixed crosslinked mass, which may then be suspended in 0.5 M NaOCl solution for four (4) hours under continuous stirring (~200 rpm) to oxidize the dried, mixed crosslinked mass, resulting in the CR-POM composite resin.

In yet another preferred embodiment, mesoporous Ti particles (TiP) may be created using the following method. A certain amount of cetyltrimethylammonium bromide (CTAB) may be added to 2-propanol under continuous stirring at room temperature (298K). To this, a calculated amount of titanium isopropoxide (TTIP) and 50% glacial acetic acid may be added under continuous mild stirring for at least two (2) hours until the solution pH is stabilized. The Ti mixture may then be heated and stirred until the gelation start. The resulting Ti mass may then be dried and subsequently heat treated before being allowed to cool to room temperature, resulting in a solid Ti mass. The heat treatment process may burn off chemical contaminants (e.g., surfactant) efficiently from the particle matrix. The solid Ti mass may then be washed with DI water and subsequently oxidized using an NaOCl solution. After oxidation, the oxidized, solid Ti mass may be separated from the NaOCl solution and washed with deionized water to remove any impurities present. The washed, oxidized Ti mass may then be dried to obtain solid particles and further heat treated to obtain the desired TiP.

For example, 0.021 mole titanium, 0.0014 mole CTAB, 0.523 mole 2-propanol, and 0.033 mole acetic acid may be combined to create a Ti mixture. The Ti mixture may be heated from room temperature to (343K) 70° C. using a water bath under mild stirring until gelation begins. The resulting Ti mass (wet gel) may then be dried overnight in a humid environment at (343K) 70° C. and subsequently heat treated for four (4) hours using a furnace at (573K) 300° C. at a rate of 2° C. heat ramp/min before being allowed to cool to room temperature. The solid Ti mass may then be washed with hot ~(343K) 70° C. deionized water and oxidized using NaOCl solution (0.1M) at pH ~2.0-5.0 for 2 to 4 hours under continuous mild stirring. After oxidation, the oxidized, solid Ti mass may be separated from the solution and washed several times with deionized water to remove any impurities present in the particles. The washed, oxidized Ti mass may then be dried overnight at (343K) 70° C. to obtain Ti particles. The Ti particles may be further heat treated for another four (4) hours using a furnace at (773K) 500° C. at a rate of 4° C. heat ramp/min to burn off any hydrocarbon that may present in the particle matrix to obtain TiP.

In yet another preferred embodiment, the surfaces of the mesoporous Ti particles (TiP) may be chemically functionalized with (3-aminopropyl)triethoxysilane (APTES) to provide active sites. The following methods may be used to create quaternary titanium-based bi-functional mesoporous material. TiP are thoroughly washed using an HCl solution under constant temperature in order to remove any contaminants from the surface of the TiP. The particles may then be rinsed with ultra-pure water (HPLC grade) until the solution pH becomes near neutral. The cleaned mesoporous Ti—P particles may then be dispersed in ethanol using sonication. APTES may then be added to the mixture, further sonicated may then be commenced. The resulting Ti-APTES mixture may then be stirred under reflux for at least 24-hours. After reflux, the resulting APTES functionalized mesoporous Ti mass may be washed with ethanol and DI water and subsequently dried, resulting in desired animated Ti particles (Ti—NH₂).

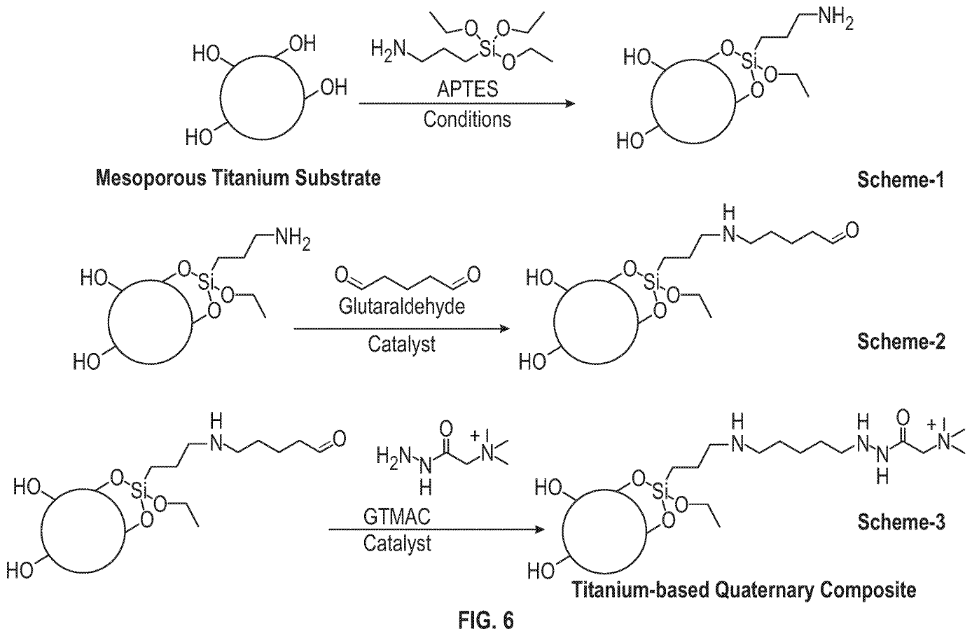

To obtain quaternary amine functionalized mesoporous titanium particles (TiP-Q), as illustrated in FIG. 6, the aminated titanium particles (Ti—NH₂) must be further crosslinked with glycidyltrimethylammonium chloride (GTMAC). This is preferably accomplished in one of two methods. In the first method, Ti—NH₂ particles may be soaked in ultrapure water under continuous stirring at room temperature with a pH of the mixture being maintained at 3.5-4.0 using 0.1M HCl. The aminated titanium (Ti—NH₂) may be activated by dropwise addition glutaraldehyde (GLA) and then keeping the mixture under stirring. The Ti—NH₂ particles crosslinked with GLA may then be washed thoroughly with deionized water and a quaternization reaction may be performed by reacting the GLA crosslinked Ti—NH₂ particles with GTMAC. The resulting crosslinked Ti mass may then be separated from the solution and thoroughly rinsed with DI before being dried to obtain a TiP-Q composite resin.

In the second method, aminated titanium (T-NH₂) may be crosslinked with GTMAC using a reductive amination process. In this process, the animated titanium particles, GLA, and sodium triacetoxyborohydride (NaBH(OAc)—) are placed in a reaction vessel containing phosphate buffer solution (PBS). The pH of the mixture is maintained at pH~4.0 and incubated under continuous stirring. An aldol condensation reaction of GLA with amine to form imine and subsequent reduction of imine to the alkyl amine product in the presence of acid as a catalyst may occur. The resulting GLA crosslinked Ti—NH₂ particles (Ti—NH₂-GLA) may then be separated from the solution and washed thoroughly with PBS and ultra-pure water. The Ti—NH₂-GLA particles may then be reacted with 10% GTMAC in ultrapure water having a pH maintained at pH~3.5-4.0 to create a GTA cross-linked Ti mass. Finally, the GTMAC crosslinked Ti mass may be washed with deionized water and dried to obtain quaternized titanium particle (TiP-Q). In order to remove any unwanted impurities, the TiP-Q particles are further oxidized by exposing them to a sodium hypochlorite (NaOCl) solution before removing them from the solution. Once removed, the TiP-Q particles may be washed with DI water and dried.

For example, TiP particles may be thoroughly washed using 1% HCl solution while under constant temperature to remove any contaminants from the surface of the TiP. The particles may then be rinsed with ultra-pure water (HPLC grade) until the solution pH becomes near neutral. Approximately, 1 gram of the cleaned mesoporous Ti—P particles may be dispersed in 200 mL of ethanol using sonication for 20 minutes. To this, a known amount of APTES (8 mL) may be added before undergoing further sonicated for 10 minutes. The mixture may then be kept under constant stirring for at least 24 hours at 343K (70° C.) under reflux. Finally, the APTES functionalized mesoporous Ti particles may be washed with ethanol and de-ionized water several times to remove residual APTES and then dried in an oven overnight at (333K) 60° C.

The Ti—NH₂ particles may be crosslinked by soaking approximately one (1) gram of the Ti—NH₂ particles in 100 mL ultrapure water under continuous stirring at room temperature, wherein the pH of the mixture is preferably maintained between 3.5-4.0 using 0.1M HCl. The Ti—NH₂ may be activated by dropwise addition of 1 mL of 50% glutaraldehyde (GLA) and subsequently keeping the mixture under gentle stirring for two (2) hours. The Ti—NH₂ particles crosslinked with GLA may then be washed thoroughly with deionized water to remove any unreacted reaction components. Finally, the quaternization reaction may be performed by reacting the GLA crosslinked Ti—NH₂ particles with 10% GTMAC in deionized (HPLC grade) water for 12 hours under continuous stirring at 30° C. Approximately one (1) gram of GLA crosslinked T-NH₂ particles is then transferred to a vial containing 10 mL of deionized water with a pH maintained between 3.5-4.0 using 0.1M HCl. To this, approximately one (1) gram of GTMAC may be added and the mixture may then be kept under continuous stirring (200 rpm) at 298K (25° C.) overnight. The resulting crosslinked mass may then be separated from the solution and thoroughly rinsed with DI water to remove any adhered unreacted cross-linking agent (GTMAC). The crosslinked mass may be dried in an oven at 318K (45° C.) overnight to obtain the TiP-Q composite resin.

Alternatively, T-NH₂ may be crosslinked with GTMAC by adding approximately one (1) gram of Ti—NH₂, 100 mM of sodium triacetoxyborohydride, and 1 mL of 50% GLA to a reaction vessel containing 100 mL of PBS. The pH of the mixture is preferably maintained at pH of ~4.0 using 0.1% (v/v) acetic acid. The mixture may be incubated for four (4) hours at 298K (25° C.) under continuous stirring. The resulting Ti—NH₂-GLA particles may be separated from the solution and washed thoroughly with PBS and finally with ultra-pure water (HPLC grade). The Ti—NH₂-GLA particles may then be reacted with 10% GTMAC in ultrapure water for 12 hours under continuous stirring at 298K (25° C.). The pH of the mixture is preferably maintained at a pH between ~3.5-4.0 using 0.1M HCl. Finally, the GTMAC crosslinked titanium particles may be washed with deionized water and dried at 318K (45° C.) to a constant weight. In order to remove any unwanted impurities, the TiP-Q may be further oxidized by exposing it to 0.1M sodium hypochlorite (NaOCl) solution for at least two (2) hours under slow stirring at a pH of ~4.0. Finally, the TiP-Q particles may be separated from the solution and washed with deionized water and dried at 318K (45° C.) to a constant weight.

In yet another preferred embodiment, iron doped meso-porous titanium material (TF) may be prepared by the hydrolysis and condensation reaction of titanium alkoxide and iron in which aqueous organic media is used as a template. TTIP may be mixed with ethanol under continuous stirring and heating. Ferric chloride (10 mL) may be added dropwise to the mixture while under constant stirring followed by the addition of acetic acid to adjust the pH of the mixture. Ethylene glycol is then added as a stabilizer and the solution may be heated until a wet gel is formed. The wet gel may be dried and heat treated in order to obtain a TF material. The TF material may then be oxidized in a NaOCl solution and washed with deionized water to remove any impurities present therein. The cleaned TF material may then be dried overnight.

For example, an amount of TTIP may be mixed with 25 mL ethanol under continuous stirring and heating at 70° C. (343K) to create a Ti mixture. Under stirring, water solution of ferric chloride (10 mL) may be added dropwise to the Ti mixture to create a Ti—Fe mixture. The molar ratio of titanium and iron is preferably 0.54:0.46 in the mixture. This is followed by adding approximately 2 mL of acetic acid to adjust pH of the Ti—Fe mixture. To this, at least 2 mL ethylene glycol may be added as stabilizer and the solution may be heated at (343K) 70° C. to form a wet gel. The wet gel may be further heated overnight at (343K) 70° C. in an oven and subsequently heat treated in a furnace at (473K) 200° C. at a rate of 2° C./minute temperature increase and then kept for 4 hours until a TF material is obtained. The TF material may be oxidized in a NaOCl solution (0.1M) at pH ~2-5 for 2 to 4 hours under continuous stirring. The oxidized TF material may then be separated from the solution and washed several times with deionized water to remove any impurities present in the TF material. The cleaned TF material may then be dried overnight at (343K) 70° C.

In yet another preferred embodiment, a TF-1 composite resin may be created by following the method for creating a TF material but with the addition of oxalic acid in the early steps. It is assumed that ethylene glycol inhibits precipitation of the metal ions, thus stabilizing the reaction process. Furthermore, it may facilitate pore formation in the gel matrix upon heat treatment in the furnace. The possible polymerization reaction among the components can be as follows:

MC₂O₄·2H₂O+HOCH₂CH₂OH→MC₂O₄(HOCH₂CH₂OH)+2H₂O (2)

In Equation 2, the “M” is for iron and titanium. It is important to note from the preliminary studies that the drying and calcination temperature also has effects on the crystalline phase of the material. This phenomenon affects the crystallization pattern and also characteristics of the final powder, which has direct effects on adsorption performance of the material.

To produce a TF-1 composite resin, TTIP may be mixed with ethanol under continuous stirring and heating. Ferric chloride (10 mL) may be added dropwise to the mixture while under constant stirring followed by the addition of acetic acid to adjust the pH of the mixture. An oxalic acid solution may be added to the Ti—Fe mixture under continuous stirring and to that ethylene glycol may be added as stabilizer before heating under continuous stirring. A polymerization reaction between the reaction components (Ti, Fe, ethanol, oxalates and ethylene glycol) results in a viscous wet gel. The viscous gel may be dried to create a semi-solid wax-like gel, which may then be heat treated and then left to cool down to room temperature. This heating process facilitates the formation of solid TF-1 composite particulate materials. The TF-1 composite particles may be washed with de-ionized water and oxidized in a NaOCl solution under continuous stirring. After oxidation, the oxidized TF-1 composite particles may be separated from the solution and washed with deionized water to remove any impurities. Finally, the cleaned, oxidized, TF-1 composite particles may be dried overnight in order to obtain the desired TF-1 composite resin.

For example, an amount of TTIP may be mixed with 25 mL ethanol under continuous stirring and heating at 70° C. (343K). Under stirring, water solution of ferric chloride (10 mL) may be added dropwise to the mixture. The molar ratio of titanium and iron is preferably 0.54:0.46 in the mixture. Approximately, one (1) gram oxalic acid may be dissolved in 10 mL de-ionized water and then added slowly to the Ti—Fe mixture under continuous stirring. To this, at least 2 mL ethylene glycol may be added as stabilizer and the solution may be heated at (343K) 70° C. under continuous stirring for approximately three (3) hours, resulting in the formation of a viscous wet gel. The viscous wet gel may be further heated overnight at (343K) 70° C. in an oven until a semi-solid wax-like gel is formed. This semi-solid wax-like gel may be further heated in a furnace at (623K-673K) 300° C.-350° C. at a rate of 2° C./minute temperature increase and then kept for 4 hours and then left to cool down to room temperature to create solid TF-1 composite particulate materials. The TF-1 composite particles may be washed twice with de-ionized water and then oxidized in a NaOCl solution (0.1M) at pH ~2.0-5.0 for 2 to 4 hours under continuous slow stirring. After oxidation, the oxidized TF-1 composite particles may then be separated from the solution and washed several times with deionized water to remove any impurities present therein. Finally, the cleaned, oxidized TF-1 composite particles may be dried overnight at (343K) 70° C. to obtain a TF-1 composite resin.

In some preferred embodiments, both TF and TF-1 samples may be calcined in a furnace at 823K (500° C.) to (873K) 600° C. at a rate of 4° C./minute temperature increase and then kept for 4 hours. Once calcined, both TF and TF-1 samples may be left to cool down to room temperature to obtain iron doped mesoporous Ti powder. TF particles may be further reduced using NaBH₄ (1M) prior to being used to adsorb Tc-99m.

In yet another preferred embodiment, a mesoporous Ti-POM material may be prepared following TF-1 preparation process with a substitution of a water-soluble manganese source, water-soluble phosphate source, water-soluble tungstate source, and water-soluble cobalt source dissolved in solution for that of the ferric chloride solution. To create a Ti-POM composite resin, an amount of TTIP may be mixed ethanol under continuous stirring and heating to create a Ti solution. Sodium molybdate, manganese chloride, sodium phosphate, sodium tungstate, and cobalt chloride may be added to a beaker containing a phosphoric acid solution under continuous stirring to obtain clear solution that may then be mixed into the Ti solution to create a mixed Ti solution. In a preferred embodiment, the atomic weight percentage of the Ti, Mo, Mn, W, Co, and P in the clear solution is Ti (52%), Mo(8.13%), Mn (5.73%), W (14.6%), Co (4.38%), and P (15.1%). Ethylene glycol may be added to the mixed Ti solution as a stabilizer and the mixed Ti solution may be heated until a viscous mixture is formed. The viscous mixture may be further heated until a semi-solid mass has been acquired, which may subsequently be heat treated and left to cool to room temperature in a way such that solid Ti-POM composite particulate materials may be created. The Ti-POM composite particles may then be oxidized in a solution of H₂O₂ having a pH between ~2-5 under continuous slow stirring. The resulting oxidized Ti-POM composite particles may be separated from the solution and washed with deionized water to obtain cleaned, oxidized Ti-POM composite particles, which may then be dried to obtain the desired Ti-POM composite resin. In some preferred embodiments, the Ti—Pom composite resin may be calcined and then cooled to room temperature in order to obtain mesoporous Ti-POM particles.

For example. TTIP may be mixed with ethanol under continuous stirring and heating to prepare a Ti solution. Simultaneously, sodium molybdate, manganese chloride, sodium phosphate, sodium tungstate, and cobalt chloride may be added to a beaker containing 10 mL phosphoric acid (10%) solution under continuous stirring to obtain a clear solution and may then mixed slowly to the Ti solution to create a mixed Ti solution. To this, at least 2 mL ethylene glycol may be added as stabilizer and the colloidal suspension may be heated for approximately three (3) hours at (343K) 70° C. until a viscous mixture is formed. The viscous mixture may be further heated overnight at (343K) 70° C. in an oven until a semi-solid mass is formed, which may then be further heated in a furnace at (473K) 200° C. at a rate of 4° C./minute temperature increase and then kept for 4 hours and then left to cool down to room temperature to acquire solid Ti-POM composite particulate materials. The Ti-POM composite particles may then be oxidized via a 3% H₂O₂ solution having a pH between ~2.0-5.0 for 2 to 4 hours while under continuous slow stirring. After oxidation, the oxidized, Ti-POM composite particles may be separated from the solution and washed several times with deionized water to remove any impurities present in the particles. The cleaned, oxidized, Ti-POM composite particles may then be dried overnight at (343K) 70° C. to obtain the desired Ti-POM composite resin. The Ti-POM composite resin may be further processed via calcination in a furnace at (873K) 600° C. to (1173K) 900° C. and then allowed to cool to room temperature to obtain mesoporous Ti-POM particles. The temperature increase in the furnace may be maintained at a rate of 4° C./minute and then kept for 4 hours.

### Study of Applications of Chitosan Based Composites and Ti Based Composites and Analysis Thereof

Hundreds of storage tanks across the United States contain radioactive wastes that need to be remedied. The composition of the wastes in these storage tanks is rather complex. The High-level tank waste that has been processed to remove most of the Cs-137 and Sr-90 may be re-classified as Low Activity Waste (LAW). The waste that is alkaline in nature is abundant with high concentrations of sodium salts of nitrate, nitrite, hydroxide, carbonate, and phosphate. It has been reported that the potential troublesome radionuclide remains in the LAW waste after pretreatment is the long-lived Tc-99. Technetium is pertechnetate anion

$$[ Tc {O}_{4}^{-} ] ,$$

which can be dominant in the waste solution at the pH range of 0 to 14. In aqueous solution, the

$$Tc {O}_{4}^{-}$$

ion is highly mobile, and it has a long half-life, complex redox chemistry, solubility, and also volatility at high temperatures. Once escaped to the environment,

$${Tc O}_{4}^{-}$$

ion can diffuse rapidly through geological systems. Simulant was prepared by mixing calculated amounts of Na₂HEDTA, Al(NO₃)₃·9H₂O, NaNO₂, NaNO₃, Na₂CO₃, Na₂S, NaOH, KNO₃, and MgSO₄, and a sufficient amount of DI water in a volumetric flux. Aliquots of the mixture were spiked with an appropriate amount of Na⁹⁹TcO₄ solution of known concentration. The concentration of pertechnetate was determined using counting (LSC) method. Table 2 shows typical composition of simulant solution containing high concentration of salt, base and other chemical constituent at pH>14. In another attempt, the simulant pH was adjusted to near neutral (~6.5 to 7.0) using appropriate amount of acid.

TABLE 2
Typical composition of simulant (S1).

| | Concentration |
|---|---|
| Component | (M) |
| Na | 1.0 |
| Al | 0.3 |
| NO₃ | 1.2 |
| NO₂ | 0.2 |
| CO₃ | 0.2 |
| K | 0.03 |
| NaEDTA | 0.02 |

Equilibrium batch adsorption studies were carried out by exposing the CF beads to simulant in 125 mL Erlenmeyer flasks to a pre-determined pH and temperature. The phase ratio was selected for the CF beads and the solution ensured that an equilibrium condition was reached, i.e., all of the metal ions were not adsorbed by the beads, which would have made it difficult to determine the equilibrium point. The flasks were placed in a constant temperature shaker bath for a specific time period. Following the exposure of CF beads to simulant, the samples were collected at predetermined time intervals. The solutions were filtered, and the filtrates were analyzed for technetium by LSC method. Inductively coupled plasma mass spectroscopy (ICP-MS) was used to evaluate the performance of the resin for germanium, gallium, uranium and molybdenum removal from aqueous solution. The adsorption isotherm at a particular temperature was obtained by varying the initial concentration of technetium ions. The amount of technetium adsorbed per unit mass of adsorbent (Qₑ) was calculated using the following equation:

$${Q}_{e} = \frac{( {C}_{i} - {C}_{e} ) V}{M} \qquad ( 3 )$$

where Cᵢ and Cₑ represent initial and equilibrium concentrations in mg/L, respectively. Vis the volume of the solution in liters (L) and Mis the mass of the adsorbent in grams.

Chitosan based CF composite resin was prepared by dispersing FeOOH nanoparticles into a chitosan matrix. The swelling behavior of CF composite resin was investigated as a function of time in solution, temperature, and pH values. The swelling ratio of CF composite resin sample can be calculated from the following expression:

$$Swelling ratio ( \% ) = [ \frac{( {V}_{s} - {V}_{d} )}{{V}_{d}} ] \times 100 \qquad 4$$

In which Vₛ is the volume of the swollen and V_{d} is the volume of dry CF composite resin sample, respectively. It was observed that the CF composite resin shows very fast swelling behavior, and it reached approximately 200% increase within 5 minutes as well as reached equilibrium at 24 hours. It was assumed that the swelling behavior of CF composite resin depends on the ionizable groups that are present within the gel structure. Due to protonation of —NH₂ groups of CF resin in the acidic pH range of solution, the swelling behavior of chitosan in deionized water can be attributed to high repulsion of

$$- {NH}_{3}^{+}$$

groups. In saline solution, at a pH higher than ~6.0, the carboxylic acid groups become ionized and the electrostatic repulsive forces between the charge sites (COO—) cause an increase in swelling. In another attempt, CF composite resin was submerged in different concentrations of HCl, HNO₃, and H₂SO₄ acid. It was observed that the physical size and shape of the CF composite resin did not show any significant change in up to 12M HCl, 12M H₂SO₄ and 1M HNO₃ solutions, respectively. The CF resin tends to disintegrate in 1M HNO₃ solution and appeared to be dissolved completely in 3M HNO₃ solution. It is evident that the CF-based composite resin is more acid resistant compared to chitosan.

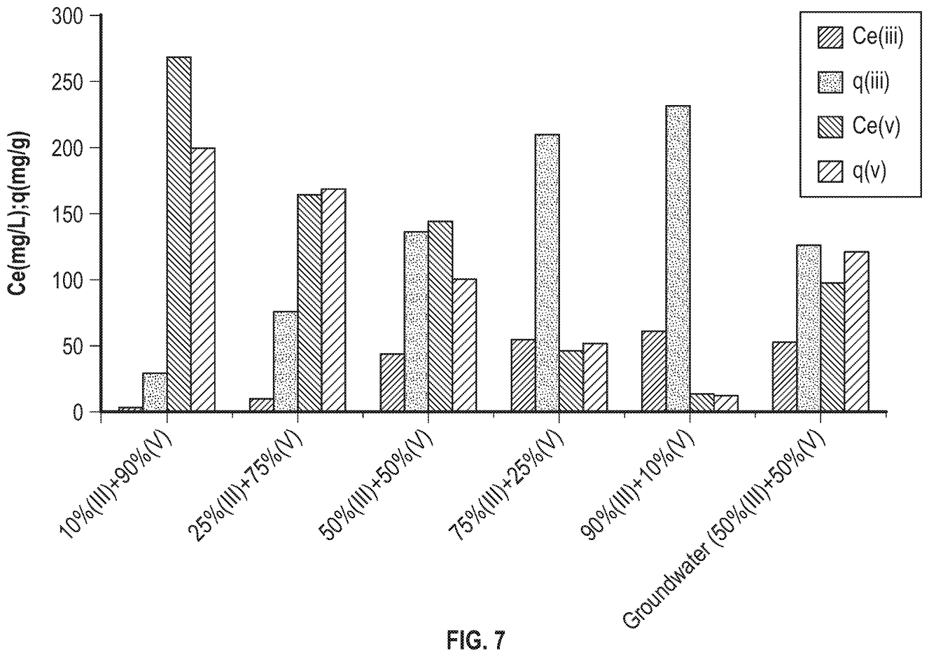

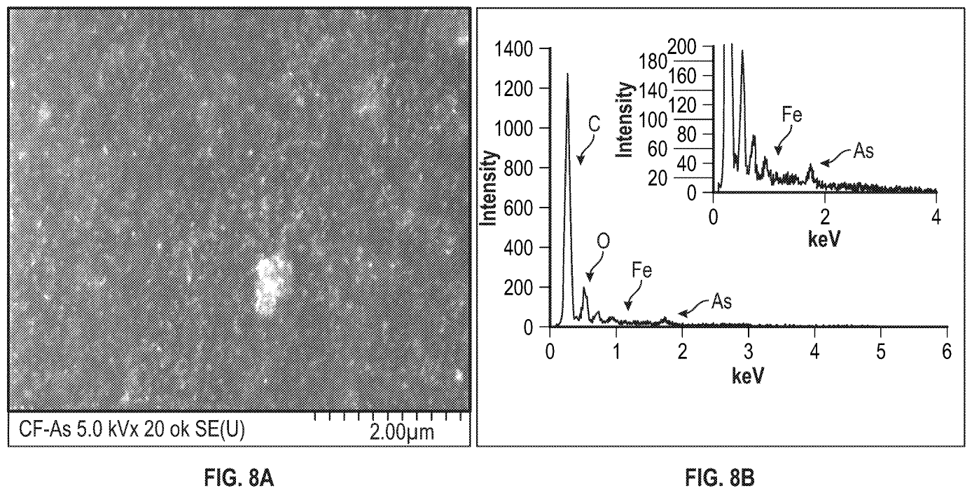

It was observed that CF-1 composite resin partially oxidized by either sodium chlorite or hypochlorite showed better performance than the un-oxidized CF-1 composite resin. The performance of the partially oxidized chitosan-based CF-1 composite resin was evaluated for the removal of anionic metal ions such as pure As(III) and As(V) from aqueous media, such as drinking water. The concentrations of arsenic in the supernatant liquids were analyzed using high performance liquid chromatographic mass spectroscopy (HPLC-MS). From the pH study, it was observed that the CF-1 composite resin had a maximum adsorption capacity at a pH of ~5.8 to 6.5. Therefore, equilibrium adsorption capacity of beads for different percentages of As(III) and As(V) in the solution in presence of 0.05M NaCl was determined at pH ~6.0 and 25° C. (298K). The initial concentration of solutions was prepared as 10%, 25%, 50%, and 90% of As(III) and made up to 100% with As(V) with a total final concentration of 1000 μg/L in each case. FIG. 7 illustrates that the equilibrium uptake capacity of CF-1 composite resin for As(III) is comparatively higher than As(V). It was observed that the amount of As(III) and As(V) uptake was 136 μg/g and 100 μg/g of beads, respectively, when the initial concentration ratio of both arsenic species was 50:50. It is also observed that the amount of As(III) uptake is 126 μg/g by beads from groundwater whereas the As(V) uptake was 120 μg/g of beads when the initial concentration was 1000 μg/L and the ratio of both arsenic species in the solution was 50:50. FIG. 8A shows scanning electron micrograph (SEM) of the CF-1 resin after their exposure to arsenic solution. Energy dispersive spectroscopy (EDS) x-ray microanalysis was performed on the same sample as was used for SEM micrograph to identify elements present on the composite beads, as illustrated in FIG. 8B. The peak for carbon and oxygen shows at 0.3 keV and 0.5 keV which is the main component of chitosan. The presence of iron at the energy level of 0.95 keV along with the arsenic at 1.8 keV was observed. It is hypothesized that the arsenic may form bonds with Fe or NH₃+ present in the beads.

Table 3 summarizes pertechnetate concentration in solution before and after batch contact with CF based sorbent materials. It was observed from Table 3 that both CF-1a and CF-2 samples remove significant amount of pertechnetate from the caustic (pH ~14) simulant. For the uptake of pertechnetate from the near neutral simulant (pH ~6.9), both CF-2 and CF-1a composite resins remove only 8.27% of 2.14×10⁻³ μCi Tc-99 and 26.3% of 1.93×10⁻³ μCi Tc-99 from the simulated solution, respectively.

TABLE 3
Pertechnetate uptake onto CF sorbents from simulant

| | | Simulant | | Phase | Tc-99 in | Tc-99 | | Tc-99 |
|---|---|---|---|---|---|---|---|---|
| | Mass | volume | | ratio | simulant | uptake, qₑ | K_{d} | uptake |
| Sorbent | (g) | (mL) | pH | L/S | μCi/mL | μCi/g | mL/g | % |
| CF-1a | 0.051 | 5.2 | ~14 | 102 | 3.6E−04 | 2.78E−02 | 316 | 75.6 |
| | 0.05 | 5.35 | ~6.8 | 107 | 3.6E−04 | 1.01E−02 | 38.1 | 26.3 |
| CF-1b | 0.052 | 5.3 | ~13.8 | 102 | 4.03E−04 | 2.25E−02 | 123 | 54.7 |
| | 0.052 | 5.35 | ~6.9 | 101 | 4.03E−04 | 1.0E−02 | 33.0 | 24.6 |
| CF-2 | 0.052 | 5.35 | ~13.8 | 103 | 4.03E−04 | 3.29E−02 | 395 | 79.3 |
| | 0.051 | 5.3 | ~6.9 | 104 | 4.03E−04 | 3.46E−03 | 9.37 | 8.27 |
| CF-2a | 0.05 | 5.0 | ~13.9 | 100 | 3.6E−04 | 2.26E−02 | 168 | 62.8 |
| | 0.049 | 5.5 | ~6.95 | 112 | 3.6E−04 | 2.03E−02 | 113 | 50.1 |

Technetium has multiple oxidation states. It is also chemically inert and has a tendency to form covalent bonds. Among all of the oxidation states for technetium, Tc(VII) is the dominate species in oxidative environments whereas Tc(IV) is prevalent species under anoxic and reducing environments. It has been reported that technetium removal is accomplished either through an ion-exchange process or a reductive process whereby the sorbent reduces the highly soluble

$${Tc O}_{4}^{-}$$

to a sparingly soluble Tc(IV) form such as Tc(IV) O₂·nH₂O. The associated redox reaction and standard reduction potential are shown in equation 5.

$${Tc O}_{4}^{-} + 4 {H}^{+} + 3 {e}^{-} ↔ Tc {O}_{2} + 2 {H}_{2} O \qquad ( 5 )$$

It has been reported that Tc(IV) redox product depends on the nature of solid phase. In CF based composite resin, iron oxyhydroxide is the integral component that is considered to be one of the main adsorption sites for Tc-99. Therefore, the sorption of Tc-99 onto CF-1a and CF-2 from simulant with alkaline pH typically describes that the adsorption of Tc-99 may result from either electrostatic attraction or electron affinity. Pertechnetate reduction by Fe(II) that is present in the CF composite resin may yield octahedral Tc(IV) monomers and dimers attached to surface Fe. It has been reported that 75% of Technetium in Hanford tank waste is not in (VII) state but is rather in the (IV) oxidation state. In comparison to the acidic pH, it is assumed that most of the Tc-99 present in the alkaline pH of the simulant was efficiently reduced to Tc(IV) by the Fe on the surface of CF composite resin. It has been reported that the association of Tc(IV) with ferric iron [Fe(III)] solid phase is strong due to their similarity in cation size, metal-oxygen bond lengths, and number of coordinating oxygen atoms. Therefore, Tc-99 uptake onto CF-1a and CF-2 composite resins from alkaline pH of the simulant was higher than the acidic pH of the simulant. In the case of CF-2 composite resin, Tc-99 uptake could result from the redox reaction of Tc-99 with the surface iron complexes. In addition, Tc-99 may further complex with the oxalate ion that is present in the CF-2 composite resin's matrix, thus increasing the Tc-99 uptake further from the alkaline simulant compared to CF-1a composite resin (Table 3).

In another attempt, the CF-1a and CF-2 composite resins were reduced by 0.1M NaBH₄ and then rinsed thoroughly with DI water to remove any adhered reducing agent. It was termed as CF-1b and CF-2a composite resins in this experiment. It was observed that the CF-2a composite resin, which is the reduced form of CF-2 composite resin, shows better performance than the CF-1b composite resin for pertechnetate uptake from both caustic and near neutral simulant (Table 3). It is reported that the carboxylic functional groups interact strongly with Tc(IV) under reducing conditions. In the case of CF-2a composite resin, it was assumed that the presence of carboxylic groups in the composite structure may further facilitate Tc-99 uptake process under reducing condition, thus increasing Tc-99 uptake compared to CF-1b composite resin. The pertechnetate uptake onto CF-2a composite resin was approximately 63% of 1.84×10⁻³ μCi and 50% of 1.98×10⁻³ μCi from the simulated solution pH of ~13.8 and ~6.9 respectively.

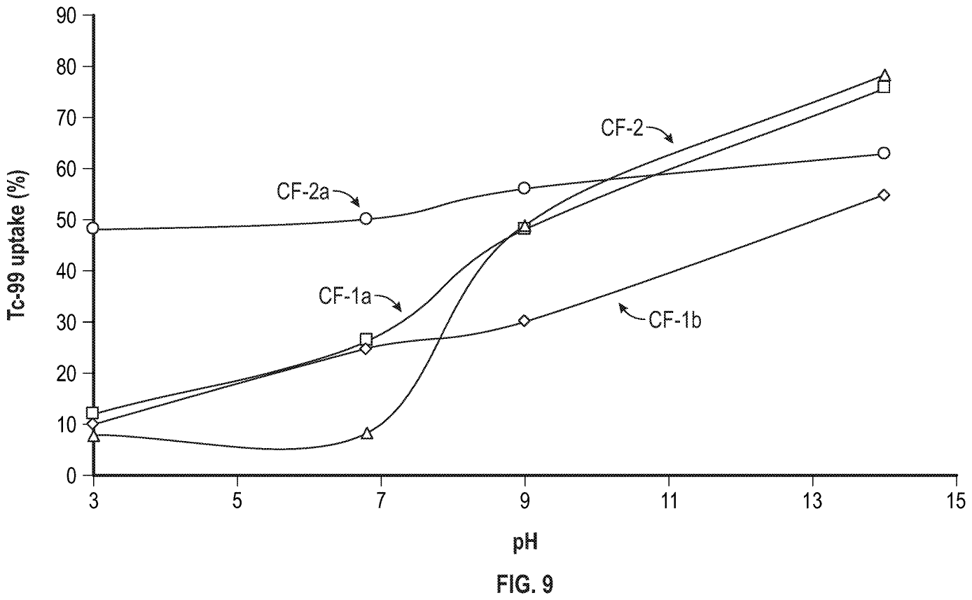

In another attempt, the performance of the CF composite resins at different pH values of Tc-99 spiked simulant was measured. FIG. 9 illustrates data for Tc-99 uptake by CF based composite resins from Tc-99 spiked simulant samples that were prepared over a range of pH values from ~3 to 14. As mentioned elsewhere, both CF-1a and CF-2 composite resin show better Tc-99 uptake from caustic simulant compared to the CF-2a composite resin. In the case of acidic to near neutral pH of simulant, the CF-2a composite resin shows better Tc-99 uptake compared to that of the CF-1a and CF-2 composite resins.

In the case of chitosan, the main functional groups responsible for metal ion adsorption are the amine groups (—NH₂). Depending on the pH of the solution, these amine groups can undergo protonation to

$${NH}_{3}^{+} .$$

The exact nature and distribution of hydroxo complexes depends on the concentration of ligands (i.e., solution pH and on the soluble metal concentration). Adsorption of

$${TcO}_{4}^{-}$$

by this ligand exchange mechanism requires an uncharged, hydroxylated surface and is thus sensitive to pH. It has been reported that the point of zero exchange (PZC) value of the amorphous iron oxide is approximately 8.5, whereas the PZC value of magnetite is in the range of 6.5±0.2. In the case of ligand exchange processes, a pertechnetate anion replaces a surface hydroxyl group (>SOH), which can be illustrated as follows:

$$> SOH + {TcO}_{4}^{-} = S - {OTcO}_{3} + {OH}^{-} \qquad ( 6 )$$

In the case of the CF-2a composite resin, the adsorption of pertechnetate by the ligand exchange mechanism is possible only under near neutral pH conditions in a solution. However, at pH values below the PZC, the positively charged iron surface may adsorb anionic metal ions by an electrostatic mechanism. It was assumed that the presence of carboxylic ions can make CF-2a composite resin amorphous by creating more reactive surface sites and increase ionic conductivity. Therefore, a CF-2a composite resin prepared using oxalic acid may facilitate electron distribution in the resin matrix during the reduction process. In another way, iron may chelate with carboxylic groups and interact strongly with Tc(IV) under reduced condition of the CF-2a composite resin. Therefore, the presence of carboxylic groups in the CF-2a composite resin creates a more conducive environment for Tc-99 uptake when pH ranges of the simulant are from approximately 3.0 to 14 compared to other CF based composite resins.

In another attempt, the reduced form of titanium-based mesoporous TF resins and CF resins was exposed to simulated solution S2 that was spiked with Tc-99 at solution having a pH of ~3.3. It is important to note that the simulant solution S2 was prepared using saline solution with ~3M NaNO₃ and the solution pH was adjusted to ~3.0 using 0.1N HCl or HNO₃. Table 4 shows that the pertechnetate uptake onto CF-1a, CF-1b, and CF-2a composite resins was more or less the same from the acidic simulant (S2) solution. The equilibrium uptake of pertechnetate was in the range of 1.05×10⁻² to 1.18×10⁻² μCi/g of resin with K_{d} value ranges from 37 to 43 L/Kg.

TABLE 4
Pertechnetate uptake onto reduced CF sorbents from simulant solution S2

| | | | | | | Simulant S2 | | |
|---|---|---|---|---|---|---|---|---|
| | Mass of | | | | | | | qₑ |
| | the | Simulant | Phase | Tc-99 in | | qₑ | | (Equivalent |
| | sorbent | volume | ratio | simulant | | (Tc-99) | K_{d} | Tc-99m) |
| Sorbent | (g) | (mL) | L/Kg | μCi/mL | pH | μCi/g | mL/g | (Ci/g) |
| CF-1a | 0.06 | 20 | 333 | 3.15E−04 | ~3.0 | 1.08E−02 | 38.2 | 3.33 |
| CF-2a | 0.061 | 20 | 328 | 3.15E−04 | ~3.0 | 1.18E−02 | 42.3 | 3.64 |
| CF-1b | 0.06 | 20 | 333 | 3.15E−04 | ~3.0 | 1.05E−02 | 37.0 | 3.24 |
| TF | 0.065 | 20 | 308 | 3.15E−04 | ~3.0 | 7.48E−03 | 25.7 | 2.31 |
| TF-1 | 0.065 | 20 | 308 | 3.15E−04 | ~3.0 | 9.98E−03 | 35.3 | 3.08 |

It is important to note that the CF-1a and CF-1b composite resins show less affinity for Tc-99 from both simulants (S1 and S2) compared to CF-2 based composite resins. In the case of CF-1b composite resin, the functional groups only in the surface of the resin are reduced during the reduction process. Equivalent Tc-99m uptake of the resins as shown in Table 4 was calculated using following equations:

$${A}_{Tc - 99} = \frac{{A}_{Tc - 99 m} ( {N}_{Tc - 99} \times {λ}_{Tc - 99} )}{( {N}_{Tc - 99 m} \times {λ}_{Tc - 99 m} )} \qquad ( 7 )$$

$${A}_{Tc - 99 m} = \frac{{A}_{Tc - 99} \times {t}_{\frac{1}{2} T c - 99}}{{t}_{\frac{1}{2} Tc - 99 m}} \qquad ( 8 )$$

$$λ = \frac{0.693}{{t}_{1 / 2}} \qquad ( 9 )$$

It is important to note that the titanium based mesoporous material (TF-1) is also capable of adsorbing ~3.08 Ci Tc-99m equivalent/gram of composite.

In another attempt, the TiP-Q and QCR composite resins were exposed to 1% molybdenum solution, respectively. In order to adsorb a metal ion on an adsorbent from a solution, it should form an ion in the solution. The types of ions formed in the solution and the degree of ionization depends on the pH of the solution. It has been reported that at relatively high and low pH values, both the

$${MoO}_{4}^{2 -}$$

and various isopolyanions

$$( {mainly Mo}_{8} {O}_{24}^{6 -} )$$

predominate. The

$${MoO}_{4}^{2 -}$$

anion under formation of many different polyanions in acidic solution. It was observed that both the control and QCR composite resin had a maximum adsorption capacity in molybdenum solution at a pH of about 3.0. Therefore, all the batch uptake experiments were performed at solution pH ~3.0 unless stated otherwise. The molybdenum solution was prepared with ammonium molybdate salt with 20 mM sodium hypochlorite as an oxidizer. It was assumed that the oxidizing agent will keep molybdenum as Mo(VI) form in acidic solution, thus preventing precipitation. Table 5 illustrates that the uptake of molybdenum onto the TiP-Q and QCR composite resins was relatively higher than the control chitosan resin (CR).

In QCR, chitosan resin was crosslinked with GTMAC, which lead to an increased electrostatic attraction between positive quaternized groups and sorbate anion. GTMAC is widely used for starch modification in food and paper industries. In chitosan, the nitrogen in amino groups has a lone pair of electrons that behaves as nucleophilic agent. The overall reaction between GTMAC and chitosan proceeds via electrophilic substitution of nitrogen to yield quaternized-chitosan salt. The quaternized-chitosan salt is soluble in water in a wide range of pH values compared to chitosan that is soluble in acidic pH solution only. It was envisaged that the cross-linking of neutralized chitosan composite (CR) resin with GTMAC introduces permanent positive charge of long chain alkyl with strong physical entanglement that may produce a more compact network structure with the amine groups (—NH₂) of CR resin. It has been reported that the amine groups of chitosan and methyl ammonium chloride groups in GTMAC can be protonated to form NH³⁺ and (—N⁺(CH₃)₃) groups under sub-acidic condition. It is important to note that in preparation of TiP-Q material, modified titanium mesoporous particles were cross-linked with GTMAC and a similar cross-linking reaction mechanism between GTMAC and modified mesoporous titanium particles is anticipated.

TABLE 5
Molybdenum uptake onto chitosan and functionalized chitosan (QCR) resin

| | | | Initial | | | |
|---|---|---|---|---|---|---|
| | Mass of | Amount | concentration | Phase | | Amount uptake, |
| | sorbent | of solution | of solution | ratio | pH of the | qe |
| Sorbent | (g) | (mL) | (mg/L) | L/Kg | solution | (mg/g) |
| (CR) | 0.1 | 30 | 10,000 | 300 | ~3 | 500 |
| QCR | 0.1 | 30 | 10,000 | 300 | ~3 | 650-750 |
| TiP-Q | 0.1 | 30 | 10,000 | 300 | ~3 | 500-600 |
| CR-Hf | 0.1 | 30 | 10,000 | 300 | ~3 | 350-400 |

For CR composite resin, the main functional group responsible for metal ion adsorption is the amine (—NH₂) group. Depending on the solution pH, these amine groups can undergo protonation to NH³⁺ or (NH₂—H₃O)⁺, and the rate of protonation will depend on the solution pH. Therefore, at lower pH values, the amine groups of CR resin undergo protonation, forming NH³⁺ and leading to an increased electrostatic attraction between NH³⁺ and the anionic sorbate, such as molybdenum ion.

It is reported that the repulsive forces among the quaternary (—N⁺(CH₃)₃) groups are weaker than the protonated amine (NH³⁺) groups of chitosan. Therefore, the permanent positive molecular chain of quaternary groups (—N⁺ (CH₃)₃) of QCR and TiP-Q composite resins in acidic conditions is assumed to be more flexible than the protonated amine groups (NH³⁺) of CR composite resin. This phenomenon facilitates more interaction of quaternary groups with anionic molybdenum ions than the protonated amine groups (NH³⁺) of CR composite resin, thus increasing molybdenum uptake capacity in the QCR resin. Table 5 illustrates that the uptake of molybdenum onto TiP-Q and QCR composite resins increases significantly compared to CR composite resin.

In Table 5, the CR-Hf composite resin shows the capacity for molybdenum in the range of 350 to 400 mg Mo/gram of resin. In the case of CR-Hf composite resin preparation, once Hafnium chloride is incorporated into the chitosan matrix, the formation of a strong oxidizing agent, such as hafnyl chloride, occurs from the hafnium chloride salt in the solution. This phenomenon may auto-oxidize the unreacted or unsaturated components in the resin and thus maintain an auto-oxidation environment in the resin matrix. The amount of Hf ions present in the resin matrix may offset the resin performance for molybdenum uptake compared to that of the CR composite resin.

The potential for Tc-99m uptake onto various CF and TF-based composite resin was also evaluated. Certain amounts of CF-2, CR-POM, TF-1, and Ti-POM resins were further conditioned to facilitate Tc-99m adsorption. The reduction studies of composite resin with either freshly prepared sodium borohydride or ascorbic acid were performed to determine whether reduction alone would improve technetium-99m uptake onto the resins. It is important to note that freshly prepared NaBH₄ (1M) was used to reduce the CF-2 and TF-1 composite resin. Since CR-POM and Ti-POM resins contain a certain percentage of Mo and W in their respective structure, ascorbic acid (1M) was used for their reduction process.

About 0.1 g of each type of composite resin was weighed into a series of scintillation vials containing 10 mL freshly prepared solutions of either sodium borohydride (1M) or ascorbic acid (1M) under continuous stirring. The pH value of the solutions was not adjusted during reaction. The solutions were then kept in a shaker (100 rpm) for 1 hour at 25±1° C. After 1 hour, the excess liquid was pipetted off, and the composite resin washed with deionize water (3×10 mL). The composite resin was transferred as a slurry to an empty 1 mL filter tube and sealed. The composite resin in the tube (resin cartridge) was then washed with at least 10 mL deionized water with pH 4.0. The solution pH of the deionized water was adjusted using 0.1M HCl. The ends of the resin cartridge were sealed for the next step. In this step, the Tc-99m eluent was passed through the resin cartridge slowly (1 mL/min) using a peristaltic pump and the flow through was collected. The composite resin was then washed with 5 mL of pH 4.0 deionized water and combined with the above flow through. The activity of the resin cartridge and the activity in the flow through were measured in a dose calibrator. The cartridge was then flushed with 10 mL saline with 2% H₂O₂ as an eluent to determine if the captured Tc-99m could be released. This process was followed for all the composite resins that were evaluated in this step. Table 6 shows Tc-99m uptake onto various reduced forms of the composite resins.

TABLE 6
Tc-99m uptake onto resins

| | | | | Activity in | | % Tc-99m |
|---|---|---|---|---|---|---|
| | | | Activity of | flow | | released |
| | | Activity of | Tc-99m on | through | | during elution |
| | Conditioning | Tc-99m | resin | and wash | % Tc-99m | with saline + |
| Resin | agent | (inlet) | cartridge | water | uptake | 2% H₂O₂ |
| CF-2 | Sodium | 200 MBq | 200 MBq | — | 100 | 90 |
| | borohydride | | | | | |
| | (1M) | | | | | |
| TF-1 | Sodium | | 200 MBq | — | 100 | 96 |
| | borohydride | | | | | |
| | (1M) | | | | | |
| CR-POM | Ascorbic | | 200 MBq | — | 100 | 85 |
| | acid (1M) | | | | | |
| Ti-POM | Ascorbic | | 200 MBq | — | 100 | 89 |
| | acid (1M) | | | | | |

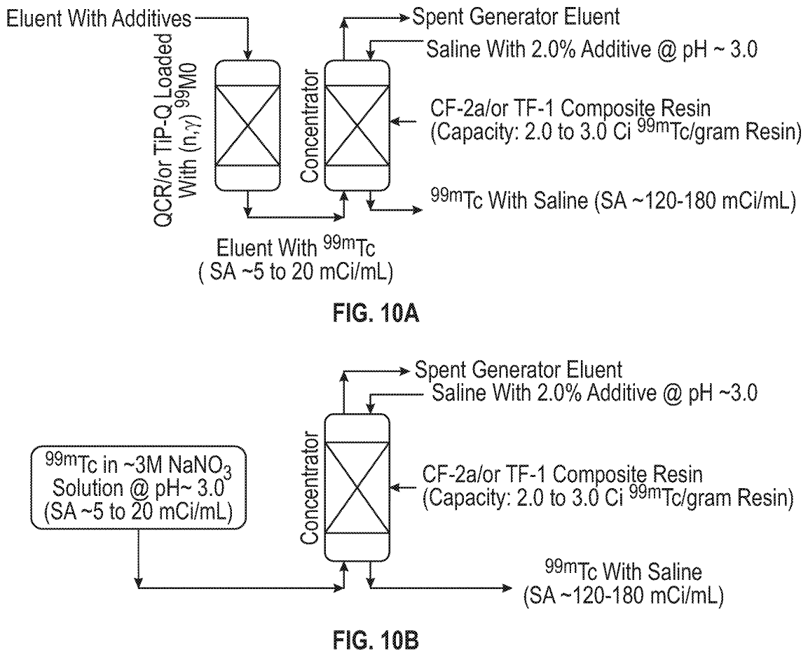

The production of (n,γ) ⁹⁹Mo draws attention as an alternative of fission derived ⁹⁹Mo due to non-proliferation issues. However, it is evident that the specific activity of ^{99m}Tc produced by the neutron capture method is not sufficiently high compared to the specific activity of ^{99m}Tc obtained from fission based ⁹⁹Mo generator. This limitation, however, can be overcome by the use of a small volume concentration column in the (n,γ) ⁹⁹Mo based generator. It is evident that almost ~2.0 Ci equivalent amount of ^{99m}Tc/gram can be adsorbed onto a small column containing CF-2a resin, as illustrated in Table 4 and FIG. 9. Approximately 90% of the adsorbed technetium can be desorbed using a small volume of 10-15 mL of eluent. It is also observed from batch studies that TF-1 material can adsorb approximately 3.08 Ci equivalent amount of ^{99m}Tc/gram. Therefore, both CF-2a and TF-1 resin can be good candidates as Tc-99m concentrator composite resin. From the above findings, it was envisaged that the ^{99m}Tc with low specific activity from a (n,γ) ⁹⁹Mo based column can be easily concentrated in a small volume column. The adsorbed ^{99m}Tc can be easily desorbed from the concentrator column using a small volume of desorption solution, which is deemed compatible with kit chemistry. Therefore, it was further envisaged that in comparison to the fission-based generator, ^{99m}Tc with high specific activity from a (n,γ) ⁹⁹Mo based generator is possible. FIGS. 10A and 10B illustrate a schematic of a ⁹⁹Mo/^{99m}Tc generator system that is proposed based on the findings mentioned elsewhere. In this approach, a chromatographic column containing molybdenum loaded QCR or TiP-Q composite resin can be eluted with ~3M NaNO₃ solution with pH ~3.0 using either peristaltic pump or vacuum vial at the flow rate of 1 mL/min. The resulting ^{99m}Tc stream with low specific activity (approximately 5 to 20 mCi/mL) should be used as feed for the concentrator column. It was estimated from the cold-test demonstration run that either CF-2a or TF-1 resin in the concentrator column is capable of holding ~3.0 Ci ^{99m}Tc (equivalent)/gram of resin, as illustrated in FIG. 10A. FIG. 10B illustrates that it is possible for simulated S2 solution with low specific activity of ^{99m}Tc that is collected separately to be passed through a small volume concentrator column that is located at the end user. Accordingly, it was envisaged that ^{99m}Tc with high specific activity can be obtained by adding a concentrator column unit in a ⁹⁹Mo/⁹⁹mTc(n,γ) generator system which is deemed comparable to the fission based ^{99m}Tc/⁹⁹Mo generator in terms of high specific activity.

In order to adsorb a metal ion on an adsorbent from aqueous solution, the metal ion should form an ion in the solution. The types of ions formed in the solution and the degree of ionization depends on the pH of the solution. As mentioned previously, the amino groups of chitosan can get protonated to NH₃⁺ or (NH₂—H₃₀)⁺ and the protonated amine groups NH₃⁺ can bind to negatively charged ions in the solution and induce covalent bonds.

In the case of the QCR composite resin, the functional group responsible for metal ion adsorption is the quaternary amine

$$( - {NH}_{3}^{+} )$$

group whereas for CR-Hf composite resin, the protonated NH₃⁺ or (NH₂—H₃₀)⁺, Hf⁴⁺, HfOH³⁺, and HfO²⁺ are the possible functional groups in solutions having a pH ~3.0. Depending on the solution pH, molybdenum in aqueous solution can be hydrolyzed with the formation of various species. At relatively high and low pH values both the

$${MoO}_{4}^{2 -}$$

and various isopolyanions

$$( mainly {Mo}_{8} {O}_{24}^{6 -} )$$

predominate. The

$${MoO}_{4}^{2 -}$$

anions undergo formation of many different polyanions in acidic solutions. It has been reported that even if the polyanion is present in the solution, the adsorption still occurs via

$${MoO}_{4}^{2 -}$$

formation. The degradation of polyanions in the solution occurs due to an increased local pH close to the adsorbent surface. It has been reported that uranium in the aqueous solution is mainly present as a cation at a lower pH value. The main hydrolyzed uranyl species in the pH range of ~3.0 to 6.0 are

$${UO}_{2}^{2 +} ,$$

UO₂(OH)⁺, (UO₂)₂

$${( O H )}_{2}^{2 +} , and {( {UO}_{2} )}_{3} {( O H )}_{5}^{+} .$$

The fraction of negatively charged hydrolysis products in the solution increases as the pH increases. By taking advantage of the difference in tendency of molybdenum and uranium ions to polymerize in solutions having a pH ~3.0, the QCR and CR-Hf composite resins were investigated. The pH-dependence of the sorption behavior of QCR and CR-Hf composite resins as evaluated for molybdenum (V1) and uranium (V1) by the batch equilibrium method.

In the case of molybdenum uptake from solution, it was observed that the QCR composite resin showed maximum adsorption capacity at solution pH ~3.0. Therefore, equilibrium adsorption capacity of QCR composite resin for different percentages of molybdenum and uranium in the solution was evaluated at pH ~3.0 and 25° C. The initial concentration of solutions was prepared as 0.5%, 10%, 25%, 50%, and 90% of molybdenum and made up to 100% with uranium. Following the exposure of the QCR composite resin to uranium and molybdenum mixture, the solutions were filtered, and the filtrates were analyzed for molybdenum and uranium via inductive coupled plasma (ICP) mass spectrophotometer.

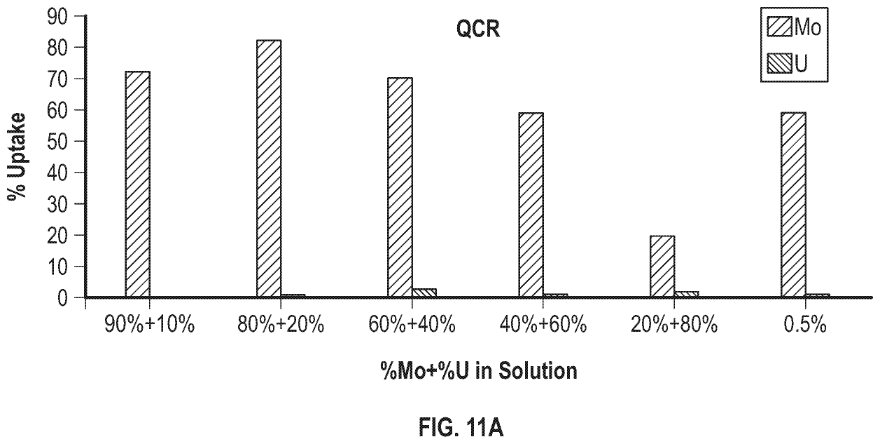

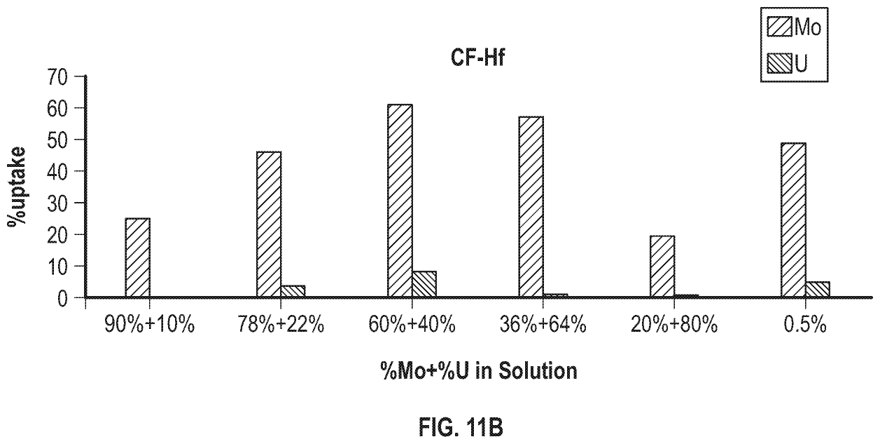

The equilibrium uptake capacity of the QCR and CR-Hf composite resins for molybdenum and uranium from different percentages of molybdenum and uranium mixtures are also shown in FIGS. 11A and 11B. Preliminary data indicates that both composites are capable of separating molybdenum selectively from the mixture of molybdenum and uranium. From the above experiments, it was envisaged that molybdenum ions can be separated from the waste solution of molybdenum production from lower enriched uranium (LEU) based process. A series of columns containing the QCR composite resin, CR-Hf, or both the QCR and CR-HF composite resins can be used to extract trace amounts of Mo-99 from the processing waste water of LEU based Mo-99 production process.

The performance of the Ti based and chitosan based composite resins were evaluated for germanium uptake from 0.05M HCl solution, respectively. Batch technique was used to carry out germanium sorption experiments using various CF and TF-based composites. Calculated amounts of each type of composites were weighed into a series of vials containing 10 mL germanium solution in 0.05M HCl. The initial concentration of the germanium in the 0.05M HCl solution was 200 mg/L in each case. The solutions were then kept in a shaker (160 rpm) for 24 hours at 298K (25° C.). After 24 hours, the solutions were centrifuged for 5 minutes at 3000 rpm to separate the supernatant from the solution. The supernatant was then filtered through a 0.45-μm membrane filter and the filtrate was analyzed for germanium removal by an inductively coupled plasma (ICP) (Agilent 7700X) that was equipped with mass spectroscopy for germanium detection. The adsorption isotherm was obtained by varying the initial concentration of germanium in the solution. The amount of germanium adsorbed per unit mass of adsorbent (qₑ) was calculated using equation 3. Table 7 summarizes germanium uptake onto various titanium and chitosan-based composite resins.

TABLE 7
Germanium (Ge) uptake onto various composite resins

| | | | | | | |
|---|---|---|---|---|---|---|
| | Amount of | | | | Final Ge | |
| | solution | Amount | Exposure | Initial Ge | concentration | |
| | (0.05M HCl) | of Resin | time | concentration | at equilibrium | Uptake |
| Resin ID | (mL) | (mg) | (hour) | (mg/L) | (mg/L) | (mg/g) |

Metal infused/Ceramic resin

| | | | | | | |
|---|---|---|---|---|---|---|
| TF | 10 | 89.7 | 24 | 261.5 | 228.6 | 3.67 |
| TF-1 | 10 | 103.1 | 24 | 261.5 | 216.6 | 4.35 |
| Ti-POM | 10 | 74.0 | 24 | 261.5 | 238.1 | 3.16 |

Composite resin

| | | | | | | |
|---|---|---|---|---|---|---|
| CF-2CG | 10 | 127.5 | 24 | 261.5 | 122.5 | 10.9 |
| CR-POM | 10 | 159.2 | 24 | 261.5 | 224.4 | 2.33 |

Table 7 illustrates the germanium uptake capacity for oxide-based TF, TF-1, and Ti-POM composite resins and chitosan-based CF-2CG, CR-POM composite resins. It was observed that the germanium uptake capacity of CF-2CG, and TF-1 resins is comparatively higher than the other composite resins as shown in Table 7. In aqueous solution, Ge(IV) can exist as Ge⁴⁺ at pH below ~2.0. As illustrated in reaction 1 and FIG. 4, CF-2CG composite resin has anionic functional groups on its surface sites. Therefore, it was assumed that the CF-2CG composite resin surfaces exhibited negative charge, and thus cationic germanium is presumably the major species being adsorbed by Coulombic interactions. Moreover, the swelling of CF-2CG composite resin favors the interaction between germanium ions with the active surface sites of the sorbent, thus enhancing the germanium uptake capacity.

In the case of the TF and TF-1 ceramic composite, the binary oxide iron-titanate (FeₓTi_{y}O_{z}) composite was synthesized using sol-gel technique and the final composite oxide material was obtained at 550° C. Table 7 shows that germanium uptake onto the TF and TF-1 composite resins is 3.67 and 4.35 mg/g of the composite, respectively. Typically, germanium (Ge⁴⁺) cations are adsorbed onto the surface of the oxide composite. It is assumed that the germanium ions interact with the strong hydrogen bonding sites of oxide surface in the adsorption process. As seen from Table 7, the TF-1 composite resin was able to adsorb more germanium ion than the TF composite resin. It is important to note that oxalic acid and ethylene glycol were used to synthesize the TF-1 composite resin, whereas acetic acid and ethylene glycol were used to synthesize the TF composite resin. It has been reported that ethylene glycol can play a substantial role on the pore arrangement in aluminum oxide membrane. In TF-1 preparation process, at first the hydrolyzed semi-solid reaction mass was heated in a furnace at 350° C. at a rate of 2° C./min temperature increase and then kept for 4 hours and then left to cool down to room temperature. It was assumed that the formation of iron titanate phases occurs at this stage with the release of products of combustion. It was then oxidized and further calcined in a furnace at 873K (550° C.) at a rate of 4° C./minute temperature increase and then kept for 4 hours and then let to cool down to room temperature. The overall reaction can be expressed using following equation:

$${MC}_{2} {O}_{4} ( H O C {H}_{2} C {H}_{2} OH ) {\to }^{Δ} {Fe}_{x} T {i}_{y} {O}_{z} + C {O}_{2} ↑ \qquad ( 10 )$$

In Equation 10, M stands for both iron and titanium in the reaction mass. In the case of TF-1 composite synthesis process, the combination of oxalic acid and ethylene glycol may facilitate more surface morphological changes by making it more porous than the TF composite resin. Therefore, the uptake of germanium was higher on the TF-1 composite resin than on the TF composite resin.

TABLE 8
Germanium (Ge) and Gallium (Ga) uptake onto Composite
resin (CF-2CG from an aqueous solution of 0.05M HCl.
Composite Resins

| | | | | Final concentration of | | | |
|---|---|---|---|---|---|---|---|
| | | | | the solution at | | | |
| | Amount | Amount of | Exposure | equilibrium | | Uptake | |
| Resin | of Resin | Solution | time | Ge | Ga | Ge | Ga |
| ID | (gram) | (mL) | (hours) | (mg/L) | (mg/L) | (mg/g) | (mg/g) |
| CF- | 0.158 | 10 | 2 | 176.0 | 171.9 | 7.898 | 4.943 |
| 2CG | 0.158 | 10 | 4 | 175.51 | 166.3 | 7.93 | 5.297 |
| | 0.158 | 10 | 8 | 180.8 | 188.94 | 7.595 | 3.865 |
| | 0.158 | 10 | 10 | 181.4 | 189.5 | 7.56 | 3.83 |
| | 0.158 | 10 | 24 | 172.5 | 170.6 | 8.12 | 5.03 |

Basis: CF-2CG (Composite resin)
Resin density: ~1.0 gram/mL
Initial concentration of Ge and Ga in the solution (0.05M HCl):
Ge: 205.4 mg/L (ppm).
Ga: 189.0 mg/L (ppm)

In another attempt, the performance of the CF-2CG, CR-POM, Ti-POM, and TF-1 composite resins was evaluated by exposing them for 24 hours in to a binary mixture of Ge and Ga in 0.05 M HCl, respectively. The initial concentration of Ge and Ga in the binary mixture was approximately 200 mg/L for each of the experiments. The data shows that CF-2CG, CR-POM, and Ti-POM uptake substantial amounts of both Ge and Ga from the solution, respectively (data are not shown). For example, Table 8 illustrates that the typical equilibrium uptake capacity of CF-2CG composite resin for Ge is comparatively higher than Ga. It was observed that the amount of Ge and Ga uptake was 8.12 mg/g and 5.03 mg/g of CF-2CG composite resin, respectively, when the initial concentration of both Ge and Ga was 200 ppm and 189 ppm in 0.05M HCl solution. In the case of the TF-1 composite resin, it was observed that the resin selectively uptakes Ge onto the resin when the initial concentration of both Ge and Ga was 200 ppm and 189 ppm in 0.05M HCl solution. Ga³⁺ ion is considered as a hard acid and it can interact more strongly to highly ionic, non-polarizable Lewis bases compare to oxide surface of the composite. It was further assumed that oxidation of the TF-1 composite resin converts lower valence metallic ions to higher valance, thus facilitating selective adsorption of germanium over gallium. Therefore, the further study of Ge-68 uptake was carried out using TF-1 composite resin is merited. Like the Tc-99m concentrator column, if a Ge/Ga system requires a Ga concentrator column, then it is imperative to note that these CF-2CG, CR-POM, and Ti-POM composite resins can be used in Ga concentrator column.

TABLE 9
Germanium (Ge) and Gallium (Ga) uptake onto TF-1
composite resin from an aqueous solution of 0.05M HCl.
Titanium-based resin

| | | | | Final concentration of | | | |
|---|---|---|---|---|---|---|---|
| | | | | the solution at | | | |
| | Amount | Amount of | Exposure | equilibrium | | Uptake | |
| Resin | of Resin | Solution | time | Ge | Ga | Ge | Ga |
| ID | (gram) | (mL) | (hours) | (mg/L) | (mg/L) | (mg/g) | (mg/g) |
| TF-1 | 0.08 | 8 | 1 | 189.16 | 190.1 | 2.08 | −0.11 |
| | 0.082 | 8 | 4 | 183.2 | 188.9 | 2.17 | 0.0097 |
| | 0.084 | 8 | 8 | 180.8 | 188.9 | 2.34 | 0.0057 |
| | 0.0814 | 8 | 10 | 181.4 | 189.5 | 2.36 | −0.049 |
| | 0.0801 | 8 | 24 | 181.7 | 189.6 | 2.37 | −0.059 |

Basis: TF-1 (Titanium-based composite)
Resin density: 1.312 gram/mL
Initial concentration of Ge and Ga in the solution (0.05M HCl):
Ge: 205.4 mg/L (ppm).
Ga: 189 mg/L (ppm)

For dynamic study, a 0.25-mL TF-1 composite resin volume was loaded into a glass column (with glass frits), capped with silicone plug to prepare generator. A solution of 10 mL of 0.05M HCl solution (spiked with 5 mCi of Ge-68) was loaded on the generator with a flow rate of 0.5 mL/min (by using a peristaltic pump). Loading solution and rinsing solutions (20 mL of 0.05M HCl) were kept for Ge-68 breakthrough measurement. The Ge-68 breakthrough is measured after decay of the Ga-68 (typically 36 hours) and measured with HPGe gamma detector.

TABLE 10
Germanium-68 (Ge) and uptake onto titanium-based (TF-1) composite
resin from an aqueous solution of 0.05M HCl (Dynamic process).

| Resin (TF-1) density | 1.319 | g/mL |
|---|---|---|
| Column volume | ~0.5 | mL (Max) |
| Amount of resin was used in the column | ~0.5 | gram |
| Conc. of the Ge-68 in the solution (Inlet) | Ge = 5 mCi/10 mL | |
| Conc of HCl in the solution | 0.05M | |
| Flow rate | 1 | mL/minute |
| Amount of Ge-68 solution passes through the | 10 | mL |
| column | | |
| Amount of rinsing solution (0.05M HCl) | 10 | mL |
| Germanium (Ge-68) retained in the column | ~100% | |
| Elution solution (0.05M HCl) | 10 | mL |
| Ge-68 breakthrough | 1 × 10⁻⁶% | |
| Volume of eluate collected in each time | 1 | mL |

| | |
|---|---|
| Total amount of Ga released from the column | ~75% |
| (outlet) | |

Table 10: Germanium-68 (Ge) and uptake onto titanium-based (TF-1) composite resin from an aqueous solution of 0.05M HCl (Dynamic process).

Table 10 illustrates the elution profile of the 0.5 mL column consisting of 0.5 gram of TF-1 composite resin loaded with 5 mCi Ge from the adsorbed Ge-68. The amount of Ge-68 retained by the column was 100%. The column started eluting with 0.05M HCl solution after 36 hours after the column was prepared and the elution was continued to determine the breakthrough. The experiment consists to elute the generator and to collect fractions of around 0.5 mL and to assay them. The elution efficiency for the daughter product Ga-68 from the column was found to be within the range of 75-90%. The total amount of Ga-68 released from the column over the period of elution with an average 75% of the loaded activity in the column. The measured breakthrough was found to be very low (<10-6%).

Although the systems and processes of the present disclosure have been discussed for use within the remediation field, one of skill in the art will appreciate that the inventive subject matter disclosed herein may be utilized in other fields or for other applications in which hemp-based composites are needed. The implementations set forth in the foregoing description do not represent all implementations consistent with the subject matter described herein. Instead, they are merely some examples consistent with aspects related to the described subject matter. Although a few variations have been described in detail above, other modifications or additions are possible. For example, the implementations described above can be directed to various combinations and sub-combinations of the disclosed features and/or combinations and sub-combinations of several further features disclosed above. In addition, the logic flow depicted in the accompanying figures and/or described herein do not necessarily require the particular order shown, or sequential order, to achieve desirable results. It will be readily understood to those skilled in the art that various other changes in the details, materials, and arrangements of the parts and process stages which have been described and illustrated to explain the nature of this inventive subject matter can be made without departing from the principles and scope of the inventive subject matter.

What is claimed is:

1. A method for producing a Ti-POM composite comprising steps of:
obtaining titanium isopropoxide (TTIP), a water-soluble molybdate source, a water-soluble manganese source, a water-soluble phosphate, a water-soluble tungstate source, a water-soluble cobalt source, an ethanol solution, a phosphoric acid solution, and an ethylene glycol solution,
combining said TTIP and said ethanol solution to create a Ti mixture,
combining said water-soluble molybdate source, said water-soluble manganese source, said water-soluble phosphate, said water-soluble tungstate source, and said water-soluble cobalt source to create a clear mixture,
adding said clear mixture to said Ti mixture to create a mixed Ti mixture,
adding said ethylene glycol solution to said mixed Ti mixture,
heating said mixed Ti mixture to create a semi-solid mass, and
heat treating said semi-solid mass and subsequently cooling said semi-solid mass to obtain Ti-POM composite particles.

2. The method of claim 1, further comprising steps of:
obtaining a NaOCl solution and deionized water,
suspending said Ti-POM composite particles in said NaOCl solution to create oxidized Ti-POM composite particles, and
washing said oxidized Ti-POM composite particles with said deionized water and subsequently drying said oxidized Ti-POM composite particles to obtain a Ti-POM composite.

3. The method of claim 2, wherein said NaOCl solution produces Cl₂ upon suspending said Ti-POM composite particles therein.

4. The method of claim 2, further comprising calcining said Ti-POM composite in a furnace at a temperature in the range of approximately 873K to 1173K at a rate of approximately 4° C. per minute and held for approximately four hours to obtain mesoporous Ti-POM particles.

5. The method of claim 2, wherein said Ti-POM composite adsorbs germanium from an acidic aqueous solution.

6. The method of claim 2, wherein said Ti-POM composite adsorbs strontium from an aqueous solution.

7. The method of claim 1, wherein said mixed Ti mixture is heated at approximately 343K under continuous stirring until said semi-solid mass is formed.

8. The method of claim 1, wherein said semi-solid mass is heat treated in a furnace at a temperature in the range of approximately 473K to 673K at a rate of approximately 4° C. per minute and held for approximately four hours.

9. The method of claim 1, wherein an atomic weight percentage of titanium, molybdenum, manganese, tungsten, cobalt, and phosphorus in said clear mixture is approximately Ti (52%), Mo (8.13%), Mn (5.73%), W (14.6%), Co (4.38%), and P (15.1%).

10. A method for producing a Ti-POM composite comprising steps of:
obtaining titanium isopropoxide (TTIP), a water-soluble molybdate source, a water-soluble manganese source, a water-soluble phosphate, a water-soluble tungstate source, a water-soluble cobalt source, a ethanol solution, a phosphoric acid solution, an ethylene glycol solution, and a hydrogen peroxide solution,
combining said TTIP and said ethanol solution to create a Ti mixture,
combining said water-soluble molybdate source, said water-soluble manganese source, said water-soluble phosphate, said water-soluble tungstate source, and said water-soluble cobalt source to said phosphoric acid solution to create a clear mixed solution,
adding said clear mixed solution to said Ti mixture to create a mixed Ti solution,
adding said ethylene glycol solution to said mixed Ti solution as a stabilizer,
heating said mixed Ti solution until a viscous mixture is formed and further heating until a semi-solid mass is obtained,
heat treating said semi-solid mass and subsequently cooling said semi-solid mass to create solid Ti-POM composite particles,
suspending said Ti-POM composite particles in said hydrogen peroxide solution having a pH in the range of approximately 2 to 5 to create oxidized Ti-POM composite particles, and
washing said oxidized Ti-POM composite particles with deionized water and subsequently drying said oxidized Ti-POM composite particles to obtain a Ti-POM composite.

11. The method of claim 10, wherein said hydrogen peroxide solution has a concentration of approximately 3%.

12. The method of claim 10, wherein said semi-solid mass is heat treated in a furnace at approximately 473K at a rate of approximately 4° C. per minute and held for approximately four hours before cooling to room temperature.

13. The method of claim 10, further comprising calcining said Ti-POM composite in a furnace at a temperature in the range of approximately 873K to 1173K at a rate of approximately 4° C. per minute and held for approximately four hours to obtain mesoporous Ti-POM particles.

14. The method of claim 10, wherein said Ti-POM composite adsorbs germanium from an acidic aqueous solution.

15. The method of claim 10, wherein said Ti-POM composite adsorbs strontium from an aqueous solution.

16. The method of claim 10, wherein said Ti-POM composite particles are ground to a particle size in the range of approximately 100 to 300 μm.

17. A method for concentrating gallium from a Ge-68/Ga-68 generator system comprising steps of:
obtaining a Ti-POM composite produced by the method of claim 10,
packing said Ti-POM composite into a small-volume column,
passing a Ge-68/Ga-68 generator eluent having a low specific activity through said column to adsorb gallium onto said Ti-POM composite, and
eluting adsorbed gallium from said column to obtain gallium at a higher concentration.

18. The method of claim 17, wherein said Ge-68/Ga-68 generator eluent is an acidic aqueous solution.

19. The method of claim 17, wherein said Ti-POM composite has a particle size in the range of approximately 100 to 300 μm.

20. The method of claim 17, wherein said Ti-POM composite removes cationic metal ions from an aqueous waste solution.
